(19) United States
(12) Patent Application Publication
(10) Pub. No.: US 2018/0197158 A1
(43) Pub. Date: Jul. 12, 2018

(54) Methods and Systems for Purposeful Playlist Music Selection or Purposeful Purchase List Music Selection

(71) Applicant: Dennis R. Smalley, Newhall, CA (US)

(72) Inventors: Olivia T. Smalley, Newhall, CA (US); TaylorAnne M. Brown, Agua Dulce, CA (US); Nicole T. Mairose, Santa Clarita, CA (US); Hae Na Lee, Stevenson Ranch, CA (US); Madison Bybee, Acton, CA (US); Teresa Smalley, Newhall, CA (US); Dennis R. Smalley, Newhall, CA (US)

(73) Assignee: Dennis R. Smalley, Newhall, CA (US)

(21) Appl. No.: 14/094,749

(22) Filed: Dec. 2, 2013

Related U.S. Application Data
(60) Provisional application No. 61/732,359, filed on Dec. 2, 2012.
(60) Provisional application No. 61/770,991, filed on Feb. 28, 2013.

(51) Int. Cl. G06Q 20/12; G06Q 30/06

(52) U.S. Cl. CPC G06Q 20/123; G06Q 30/0633; G06Q 30/0623

(57) ABSTRACT

“Embodiments provide purposeful playlists or purchase lists of music from master song or preview lists that are created using filtering, intersecting, or weighting of musical and/or lyrical features of database songs against the anticipated usefulness or inappropriateness for the given topic. Creation of master song or preview lists might also involve filtering, intersecting, weighting of database songs against a user's general musical preferences. Songs in the master song list may go directly into a purposeful playlist while songs in a master preview list may be previewed and selected for inclusion or rejected for inclusion by a user while creating a playlist or purchase list such that the list is both fully personalized and purposeful.”

### RELATED APPLICATIONS

This application is related to U.S. Provisional Application No. 61/732,359 filed Dec. 2, 2012 and to U.S. Provisional Application No. 61/770,991 filed Feb. 28, 2013. These referenced applications are incorporated herein by reference as if set forth in full.

### FIELD OF THE INVENTION

This invention relates to the field of network based electronic music storage, searching, and selection for incorporation into playlists or purchase lists and more particularly when at least some such songs are stored not only with standard information (e.g. title, genre, and date information) but also with indications of applicability of such songs to a plurality of predefined purpose topics or playlist topics (e.g. to instill wakefulness, to help induce sleep, to help one focus, to help with mediation, to help inspire strength and courage, to help energize, to get one moving, to encourage exercise at a desired intensity level, and the like) and where each such playlist or purchase list will only include songs appropriate for the selected topic (unless specifically and intentionally overridden by the user) and songs and where each song is specifically selected by the user.

### BACKGROUND OF THE INVENTION

Numerous internet based music searching, selection, playing and/or purchasing methods and systems exist or have been proposed.

Amazon.com uses a system wherein title, keywords, artist name and the like can be entered and purchasable music options presented. In some cases, previews of individual songs may be heard prior to making a purchase. This system does not provide for the creation of playlists for users but only for the purchase of music.

Pandora.com uses a system wherein a user may type in keywords, song names, or artist names and then an indeterminate (at least to the user) playlist or radio station of music is played based on the search criteria. The user has some options to customize the playlist by skipping undesirable songs after they begin to play. The user also has some ability to vary the frequency of songs appearing by rating them. This system does not provide a playlist of songs where each song is specific to the user and does not provide playlists with specific functional purposes.

Youtube.com provides for the viewing of videos and/or listening to music embedded in such videos. Specific videos are found by entering search terms such as title, artist, keywords, etc. The system does provide for the saving of playlists by registered users. The users may locate songs of their specific choosing in these playlists. The system itself however does not create purposeful song lists from which the user can select songs of particular interest for inclusion into purposeful playlists. The creation of playlists is powerful but not particularly easy to use as a certain level of skill and knowledge is required and as the user is continuously presented with distracting material. The user then may have to view a large number of videos before finding exactly what he or she is looking for. When desired videos are found the user may still be faced with having to listen to advertisements or other information prior to listening to songs that they have selected. Such distractions are not conducive to the creation and use of purposeful playlists.

A need remains in the field for improved methods and systems for producing user specific playlists and more specifically user specific playlists where each song in a playlist is appropriate for a defined purpose and is specifically selected by the user as a song to which they want to listen. A similar need exists for creating purchase lists of songs.

### SUMMARY OF THE INVENTION

It is an object of some embodiments of the invention to provide improved playlist generation methods and/or systems wherein the playlists only contain user selected songs and wherein each song in a given playlist shares a common functional purpose with each other song in the playlist.

It is an object of some embodiments of the invention to provide improved methods and systems for making music purchase selections wherein potential purchase lists are limited to songs appropriate for a user defined purpose and wherein final purchase lists are defined by users after listening to previews of at least a portion of the songs in the purchase lists.

It is an object of some embodiments of the invention to provide an internet based playlist generation or purchase list generation system. In some variations, playlists may be listened to only over the internet using a desired interface device (e.g. a personal computer, lap top, notepad, smart phone (Droid, IPhone, etc.), PDA, game system (e.g. Nintendo WII or other portable game system, Microsoft Xbox, Sony PlayStation, television, etc. while in other variations songs may be downloaded to a user's computer or other music playing device (e.g. MP3 player, laptop, notepad, PDA, smart phone, iPad, iPod, MP3 player, etc.). In some variations functionality may be provided to determine which songs the user already owns thus allowing songs to be compiled into personalized purposeful playlists from songs already owned alone or in combination with songs that may need to be purchased.

It is an object of some embodiments of the invention to provide improved methods of playing playlists wherein songs may be simply played, playlists may be played at preselected times and for preselected durations, where playlists with different functional purposes may be played in predefined orders, where songs in playlists may be normalized to maximum volume levels or dynamic ranges, and/or the like.

Other objects and advantages of various embodiments and aspects of the invention will be apparent to those of skill in the art upon review of the teachings herein. The various aspects of the invention, set forth explicitly herein or otherwise ascertained from the teachings herein, may address any one of the above objects alone or in combination, or alternatively may address some other object of the invention ascertained from the teachings herein. It is not intended that any specific aspect of the invention (that is explicitly set forth below or that is ascertained from the teachings herein) necessarily address any of the objects set forth above let alone address all of these objects simultaneously, but some aspects may address one or more of these objects or even all of these objects simultaneously. It is not intended that all aspects of the invention be simultaneously met by any specific implementation or use of the invention but that each aspect, whether explicitly set forth or ascertained from the teachings herein as a whole, independently represent such an implementation or use (e.g. method of making, method of use, apparatus, or system) of a variation of the invention.

In a first aspect of the invention a method for creating a personalized playlist of music or purchase list of music, includes: (a) accessing previously entered preferences from a survey of music preferences; (b) entering a desired playlist or purchase list topic selected from a predefined group of functional topics; (c) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (d) creating a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (e) playing a preview of a first song in the master song list for the user and soliciting feedback from the user wherein the feedback options are selected from the group consisting of: (1) adding the song to the playlist or purchase list and (2) not adding the song to the playlist or purchase list; and (f) repeating the playing and selecting until the playlist or purchase list is complete.

In a second aspect of the invention a system for creating a personalized playlist of music or purchase list of music, includes: (a) means for accessing previously entered preferences from a survey of music preferences; (b) means for entering a desired playlist or purchase list topic selected from a predefined group of functional topics; (c) means for accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (d) means for creating a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (e) means for playing a preview of a first song in the master song list for the user and soliciting feedback from the user wherein the feedback options are selected from the group consisting of: (1) adding the song to the playlist or purchase list and (2) not adding the song to the playlist or purchase list; and (f) means for repeating the playing and selecting until the playlist or purchase list is complete.

In a third aspect of the invention a system for creating a personalized playlist of music or purchase list of music, includes a visual display, one or more of a touch screen, a keyboard, a mouse or other pointing device, sound system and a program held in the memory of at least one computer and being executed by at least one programmed computer to (1) provide access to previously entered preferences from a survey of music preferences; (2) enter a desired playlist or purchase list topic selected from a predefined group of functional topics; (3) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (4) create a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (5) play a preview of a first song in the master song list for the user and soliciting feedback from the user wherein the feedback options are selected from the group consisting of: (a) adding the song to the playlist or purchase list and (b) not adding the song to the playlist or purchase list; and (6) repeat the playing and selecting until the playlist or purchase list is complete.

In a fourth aspect of the invention a system for creating a personalized playlist of music or purchase list of music, includes a visual display, one or more of a touch screen, a keyboard, a mouse or other pointing device, sound system and electronic circuitry configured to (1) provide access to previously entered preferences from a survey of music preferences; (2) enter a desired playlist or purchase list topic selected from a predefined group of functional topics; (3) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (4) create a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (5) play a preview of a first song in the master song list for the user and soliciting feedback from the user wherein the feedback options are selected from the group consisting of: (a) adding the song to the playlist or purchase list and (b) not adding the song to the playlist or purchase list; and (6) repeat the playing and selecting until the playlist or purchase list is complete.

In a fifth aspect of the invention a method for creating a personalized playlist of music or purchase list of music, includes: (a) entering a desired playlist or purchase list topic selected from a predefined group of functional topics; (b) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (c) creating a master song list by comparing an initial list of songs with at least one filtering function wherein one filtering function comprises performing a weighted or non-weighted intersection of the potential playlist or purchase list songs with the desired playlist or purchase list topic;(d) playing a preview of a first song in the master song list for the user and soliciting feedback from the user wherein the feedback options are selected from the group consisting of: (1) adding the song to the playlist or purchase list and (2) not adding the song to the playlist or purchase list; and (e) repeating the playing and selecting until the playlist or purchase list is complete.

In a sixth aspect of the invention a system for creating a personalized playlist of music or purchase list of music, includes: (a) means for entering a desired playlist or purchase list topic selected from a predefined group of functional topics; (b) means for accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song ; (c) means for creating a master song list by comparing an initial list of songs with at least one filtering function wherein one filtering function comprises performing a weighted or non-weighted intersection of the potential playlist or purchase list songs with the desired playlist or purchase list; (d) means for playing a preview of a first song in the master song list for the user and soliciting feedback from the user wherein the feedback options are selected from the group consisting of: (1) adding the song to the playlist or purchase list and (2) not adding the song to the playlist or purchase list; and (e) means for repeating the playing and selecting until the playlist or purchase list is complete.

In a seventh aspect of the invention a system for creating a personalized playlist of music or purchase list of music, includes a visual display, one or more of a touch screen, a keyboard, a mouse or other pointing device, sound system and a program held in the memory of at least one computer and being executed by at least one programmed computer to (1) enter a desired playlist or purchase list topic selected from a predefined group of functional topics; (2) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (3) create a master song list by comparing an initial list of songs with at least one filtering function wherein one filtering function comprises performing a weighted or non-weighted intersection of the potential playlist or purchase list songs with the desired playlist or purchase list topic; (4) play a preview of a first song in the master song list for the user and soliciting feedback from the user wherein the feedback options are selected from the group consisting of: (a) adding the song to the playlist or purchase list and (b) not adding the song to the playlist or purchase list; and (5) repeat the playing and selecting until the playlist or purchase list is complete.

In an eighth aspect of the invention a system for creating a personalized playlist of music or purchase list of music, includes a visual display, one or more of a touch screen, a keyboard, a mouse or other pointing device, sound system and electronic circuitry configured to (1) enter a desired playlist or purchase list topic selected from a predefined group of functional topics; (2) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (3) create a master song list by comparing an initial list of songs with at least one filtering function wherein one filtering function comprises performing a weighted or non-weighted intersection of the potential playlist or purchase list songs with the desired playlist or purchase list topic; (4) play a preview of a first song in the master song list for the user and soliciting feedback from the user wherein the feedback options are selected from the group consisting of: (a) adding the song to the playlist or purchase list and (b) not adding the song to the playlist or purchase list; and (5) repeat the playing and selecting until the playlist or purchase list is complete.

In a ninth aspect of the invention a method for creating a personalized playlist of music or purchase list of music, includes: (a) accessing previously entered preferences from a survey of music preferences; (b) entering a desired playlist or purchase list topic selected from a predefined group of functional topics; (c) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song ; (d) creating a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (d) one-by-one choosing whether or not to add songs from the master song list and making a selection to the playlist or purchase list; and (e) repeating the choosing until the playlist or purchase list is complete.

In a tenth aspect of the invention a system for creating a personalized playlist of music or purchase list of music, includes: (a) means for accessing previously entered preferences from a survey of music preferences; (b) means for entering a desired playlist or purchase list topic selected from a predefined group of functional topics; (c) means for accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song ; (d) means for creating a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (e) means for choosing one-by-one whether or not to add songs from the master song list to the playlist or purchase list ; and (f) means for repeating the choosing until the playlist or purchase list is complete.

In an eleventh aspect of the invention a system for creating a personalized playlist of music or purchase list of music, includes a visual display, one or more of a touch screen, a keyboard, a mouse or other pointing device, sound system and a program held in the memory of at least one computer and being executed by at least one programmed computer to (1) provide access to previously entered preferences from a survey of music preferences; (2) enter a desired playlist or purchase list topic selected from a predefined group of functional topics; (3) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (4) create a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (5) choose one-by-one whether or not to add songs from the master song list to the playlist or purchase list t; and (6) repeat the choosing until the playlist or purchase list is complete.

In an twelfth first aspect of the invention a system for creating a personalized playlist of music or purchase list of music, includes a visual display, one or more of a touch screen, a keyboard, a mouse or other pointing device, sound system and electronic circuitry configured to (1) provide access to previously entered preferences from a survey of music preferences; (2) enter a desired playlist or purchase list topic selected from a predefined group of functional topics; (3) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (4) create a master song list by comparing an initial list of songs with at least two filtering functions wherein one filtering function comprises performing a weighted or non-weighted intersection of the potential playlist or purchase list songs with the desired playlist or purchase list topic and a second comprises performing a weighted or non-weighted intersection of potential songs in the song list with the user's musical preferences; (5) choose one-by-one whether or not to add songs from the master song list to the playlist or purchase list t; and (6) repeat choosing until the playlist or purchase list is complete.

In a thirteenth aspect of the invention a method for creating a personalized playlist of music or purchase list of music, includes: (a) entering a desired playlist or purchase list topic selected from a predefined group of functional topics; (b) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song ; (c) creating a master song list by comparing an initial list of songs with at least one filtering function wherein one filtering function comprises performing a weighted or non-weighted intersection of the potential playlist or purchase list songs with the desired playlist or purchase list topic; (d) one-by-one choosing whether or not to add songs from the master song list and making a selection to the playlist or purchase list; and (e) repeating the choosing until the playlist or purchase list is complete.

In a fourteenth aspect of the invention a system for creating a personalized playlist of music or purchase list of music, includes: (a) means for entering a desired playlist or purchase list topic selected from a predefined group of functional topics; (b) means for accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song ; (c) means for creating a master song list by comparing an initial list of songs with at least one filtering function wherein one filtering function comprises performing a weighted or non-weighted intersection of the potential playlist or purchase list songs with the desired playlist or purchase list; (d) means for one-by-one choosing whether or not to add songs from the master song list and making a selection to the playlist or purchase list; and (e) means for repeating the choosing until the playlist or purchase list is complete.

In a fifteenth aspect of the invention a system for creating a personalized playlist of music or purchase list of music, includes a visual display, one or more of a touch screen, a keyboard, a mouse or other pointing device, sound system and a program held in the memory of at least one computer and being executed by at least one programmed computer to (1) enter a desired playlist or purchase list topic selected from a predefined group of functional topics; (2) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (3) create a master song list by comparing an initial list of songs with at least one filtering function wherein one filtering function comprises performing a weighted or non-weighted intersection of the potential playlist or purchase list songs with the desired playlist or purchase list topic; (4) one-by-one choosing whether or not to add songs from the master song list and making a selection to the playlist or purchase list; and (5) repeat choosing until the playlist or purchase list is complete.

In a sixteenth aspect of the invention a system for creating a personalized playlist of music or purchase list of music, includes a visual display, one or more of a touch screen, a keyboard, a mouse or other pointing device, sound system and electronic circuitry configured to (1) enter a desired playlist or purchase list topic selected from a predefined group of functional topics; (2) accessing song information stored in a database wherein the database includes a plurality of songs with each song of said plurality directly or indirectly identified with one or more playlist or purchase list topics (i.e. purposes) for which the song is considered applicable by the song's musical properties its lyrical properties, or other properties which have become associated with the song; (3) create a master song list by comparing an initial list of songs with at least one filtering function wherein one filtering function comprises performing a weighted or non-weighted intersection of the potential playlist or purchase list songs with the desired playlist or purchase list topic; (4) one-by-one choosing whether or not to add songs from the master song list and making a selection to the playlist or purchase list; and (5) repeat the choosing until the playlist or purchase list is complete.

In a seventeenth aspect of the invention, a method for creating a personalized playlist of music or purchase list of music, includes: (a) logging into an existing user account; (b) accessing previously entered preferences from a survey of music preferences; (c) entering a desired playlist list topic selected from a predefined group of functional topics; (d) accessing song information stored in a database wherein the database includes a plurality of songs with each song of said plurality identified, directly or indirectly, with one or more functional playlist topics (e.g. purposes) for which the song is considered applicable (e.g. by users that are members of a target culture) by the song's musical properties (e.g. beat and meter, dynamics, harmony, key, musical instruments or voice, pitch, rhythm, tempo, texture, timbre, and/or the like), lyrical properties (e.g. vocal message being conveyed), and/or other properties which have become associated with the song (e.g. cultural relevance and the like); (e) comparing the songs in the database to the functional playlist topic and producing a preliminary song list that is applicable to the topic wherein the songs in the preliminary song list are limited to only those that are appropriate to the topic or given weighting factors that are based on the level of appropriateness of the songs to the functional playlist topic; (f) using previously entered preferences, flagged songs and/or songs from artists in the preliminary song list that have been categorized by the user as a favorite to produce a flagged song list; (g) producing a secondary song list by comparing the songs in the flagged song list to a second category of preferences and either removing songs that are not preferred or providing weighting factors for the songs based on the level of preference of the songs relative to the second category of preferences; (h) producing a tertiary song list by comparing the songs in secondary song list to a third category of preferences and either removing songs that are not preferred or providing combined weighting factors for the songs based on weighting factors associated with the level of preference of the songs relative to the third category of preferences and any previously provided weighting factors; (i) producing a master song list for the functional playlist by removing songs or songs from particular artists if the user has previously indicated such songs should not be played; (j) playing a preview of a first song in the master song list for the user and soliciting feedback from the user wherein the feedback options are selected from the group consisting of: (1) adding the song to the playlist and (2) not adding the song to the playlist, and wherein the feedback options further consist of at least one additional feedback option selected from the group consisting of: (i) playing the preview again, (ii) playing an extended preview of the song, (ii) not adding the song to the playlist at this time but placing it on hold for potential inclusion in the playlist if no songs of more interest are previewed; (iv) not adding the song to the playlist but leaving the song available for consideration when creating other playlists, and (v) not adding the song to the playlist and never presenting the song again to this user; and (k)repeating the playing and selecting until the playlist is full.

A first group of variations of the seventeenth aspect of the invention and its first and second groups of variations includes one or more of (1) producing a plurality of playlists for the same user and wherein each of the plurality of playlists is directed to the same topic (i.e. has the same functional purpose) but contains at least one difference in song inclusion; (2) producing a plurality of playlists for the same user and wherein at least two of the playlists are for different topics (i.e. purposes); (3) producing a plurality of playlists for the same user and wherein the plurality includes more than two distinct topics (i.e. purposes); (4) producing a plurality of playlists for the same wherein the predefined topics comprise more than four distinct topics; (5) producing a plurality of playlists for the same user wherein the predefined topics comprise more than ten distinct topics; (6) functionality that provides a user with the ability to reorder songs in a given playlist after creation of the playlist (e.g. by dragging and dropping the songs into a desired order in the list, by moving the songs up or down past other songs in the list, or the like); (7) a display screen for use when creating a playlist that provides a plurality of the following: (a) a name of the topic of the playlist, (b) a title for the playlist, (c) a name of the current song being previewed, (d) a name of an artist that composed, is playing, or singing the current song; (e) the year of the current song, (f) a listing of the songs already selected for inclusion in the playlist, (g) a listing of the songs placed on hold, and (h) an indication of the current song number; (8) storing with a given created playlist not only the songs entered into the playlist but also information concerning the master song list, the songs already previewed from the master song list, and the songs placed on hold; (9) storing with a given playlist information about the user preferences and database that gave rise to the master song list; (10) a display that provides visual information to the user and provides an option for the user to listen to selected instructions and/or options; (11) operation (e) including taking a non-weighted intersection of the songs in the database with the desired playlist topic; (12) operation (e) including taking a weighted intersection of the songs in the database with the desired playlist topic by using weighting factors associated with applicability of each song to the desired playlist topic; (13) the comparing of at least one of steps (g) or (h) includes taking a non-weighted intersection of the songs in a current song list with songs having at least a minimum level for the user's preferences to produce a modified song list; (14) the comparing of at least one of steps (g) or (h) includes taking an intersection of the songs in a current song list with weighting factors for the user's preferences to produce a modified song list with weighted recommendations; (15) functionality for playing playlists; (16) the comparing of step (e) includes taking a weighted intersection of the songs in the database with the desired playlist topic by using weighting factors associated with applicability of each song to the desired playlist topic; (16) functionality for playing playlists wherein the functionality is selected from the group consisting of: (a) playing a selected playlist immediately, (b) playing a plurality of selected playlists in a selected order; (c) playing a selected playlist in a shuffled order; (d) playing a selected playlist in a default order; (e) playing one or more selected playlists at one or more predefined start times; (f) playing one or more selected playlists until a predefined stop time has been reached or predefined increment of time has passed; (g) setting a maximum volume level for all songs to be played during a given period; and (h) setting a range for the dynamic level of the songs to be played during a given period; (17) the playlist including multiple phases wherein at least two of the phases are characterized by different musical properties (e.g. beat and meter, dynamics, harmony, key, musical instruments or voice, pitch, rhythm, tempo, texture, timbre, and/or the like) or lyrical properties (e.g. vocal message being conveyed); (18) the different musical properties, lyrical properties, or other properties are limited to musical properties; (19) the different musical properties, lyrical properties, or other properties are include both musical properties and lyrical properties, (20) the different musical properties, lyrical properties, or other properties are include at least two of the musical properties, lyrical properties, and other properties, (21) the different musical properties, lyrical properties, or other properties are include all three of the musical properties, lyrical properties, and other properties.

A second group of variations of the seventeenth aspect of the invention includes all combinations of variations set forth in the first group so long as those combinations do not contradict one another or otherwise obviate all reason for making the combination in the first place.

A third group of variations of the seventeenth aspect and its first and second groups of variations includes changing the order of comparisons and/or other data processing steps utilized in obtaining the master song list.

A fourth group of variations of the seventeenth aspect and its first to third variations includes entering an initial number of songs to include in the playlist; and ranking the songs in the master song list according to one or more ranking categories and defining a preliminary order of preview presentation of the songs in the master song list; and determining when the playlist is full by comparing the number of songs in the playlist to the number of songs originally specified for inclusion.

In a eighteenth aspect of the invention, a method for creating a personalized playlist of music, includes: (a) logging into an existing user account; (b) accessing previously entered preferences from a survey of music preferences; (c) entering a desired playlist list topic selected from a predefined group of functional topics; (d) accessing song information stored in a database wherein the database includes a plurality of songs with each song of said plurality identified with one or more playlist topics (i.e. purposes) for which the song is considered applicable (e.g. by users that are members of a target culture) by the song's musical properties (e.g. beat and meter, dynamics, harmony, key, musical instruments and voice, pitch, rhythm, tempo, texture, timbre, and/or the like), its lyrical properties (e.g. vocal message being conveyed), or other properties which have become associated with the song; (e) creating a master song list by comparing an initial list of songs with at least two filtering functions wherein one filtering function comprises performing a weighted or non-weighted intersection of the potential playlist songs with the desired playlist topic and a second comprises performing a weighted or non-weighted intersection of potential songs in the song list with the user's musical preferences; (f) playing a preview of a first song in the master song list for the user and soliciting feedback from the user wherein the feedback options are selected from the group consisting of: (1) adding the song to the playlist and (2) not adding the song to the playlist; and (g) repeating the playing and selecting until the playlist is complete.

A first group of variations of the eighteenth aspect of the invention include, for example, one or more of (1) the feedback options consist of at least one additional feedback option selected from the group consisting of: (a) playing the preview again, (b) playing an extended preview of the song, (c) not adding the song to the playlist at this time but placing it on hold for potential inclusion in the playlist if no songs of more interest are previewed; (d) not adding the song to the playlist but leaving the song available for consideration when creating other playlists, and (e) not adding the song to the playlist and never presenting the song again to this user; (2) specifying the number of songs for inclusion in the playlist and determining when the playlist is full by comparing the number of songs placed in the playlist to the number of songs specified for inclusion; (3) the creating of the master song list further includes retaining songs that the user has entered as favorites (e.g. either as coming from to favorite artist or as a favorite song) regardless of other more general user preferences so long as the preferred songs are applicable to the desired playlist topic; (4) the creating of the master song list further includes retaining songs that the user has entered as favorites (e.g. either as coming from to favorite artist or as a favorite song) regardless of other more general user preferences but before such a favorite song is included in the playlist, the user is provided with a warning or notice that the favorite song does not have appropriate musical properties or lyrical properties for inclusion in the playlist, if such be the case, and the user is allowed to insert the song anyway; (5) the user being provided with an option to insert any song into a playlist, whether or not it meets the musical properties or lyrical properties associated with the playlist but prior to allowing such insertion the user is prompted with a warning or notice if the musical properties or lyrical properties of the song are inappropriate at which time the user may reject the song for inclusion or accept it for inclusion; (6) the producing of the master song list further includes performing at least one additional weighted or non-weighted intersection of potential songs in the song list with at least one additional category of the user's musical preferences; (7) the songs in the master song list are ranked according to one or more ranking categories prior to presentation of previews of the songs in the master song list to the user; (8) the playlist includes multiple phases and wherein at least two of the phases are characterized by different musical properties (e.g. beat and meter, dynamics, harmony, key, musical instruments or voice, pitch, rhythm, tempo, texture, timbre, and/or the like) or lyrical properties (e.g. vocal message being conveyed); (9) the different musical properties, lyrical properties, or other properties are limited to musical properties; (10) the different musical properties, lyrical properties, or other properties include both musical properties and lyrical properties; and (11)) the different musical properties, lyrical properties, or other properties include all three.

In a nineteenth aspect of the invention, a method for creating a personalized playlist of music, includes: (a) logging into an existing user account; (b) accessing previously entered preferences from a survey of music preferences; (c) entering a desired playlist topic selected from a predefined group of functional topics; (d) accessing song information stored in a database wherein the database includes a plurality of songs with each song identified by a plurality of its musical properties, lyrical properties, or other properties, which are selected from the group consisting of (1) mode (e.g. major or minor), (2) pitch (e.g. high, low, varying), (3) tempo (slow, fast, varying, beats per minute), (4) volume (e.g. soft or loud), (5) dynamics (e.g. changes in volume, rapidly, slowly, etc.), (6) sound (e.g. pleasant, harsh, consonant, dissonant), (7) rhythm (e.g. regular or smooth, irregular or rough), (8) harmony (e.g. simple, major, consonant, complex, dissonant), (9) melody (e.g. melodic direction, pitch contour, and melodic motion), (10) tonality (e.g. tonal-atonal-chromatic), (11) timbre (e.g. number of harmonics}, (12) articulation (e.g. staccato-legato), (13) amplitude envelope (e.g. round or harp), (14) musical form (complexity, repetition, new ideas, disruption, etc.), (15) interaction between these features; (16) lyrical subject matter of the song, (17) positive or negative movement of the lyrical subject matter; (18) cultural relevance of the lyrical subject matter of the song; and (19) age or generational relevance of the lyrical subject matter of the song; (e) creating a master song list by comparing an initial list of songs with at least two filtering functions wherein one filtering function comprises performing a weighted or non-weighted intersection of the potential playlist songs based on one or more musical features of the songs or lyrical features of the songs with the appropriateness of those features for purposeful use in the desired playlist topic and a second comprises performing a weighted or non-weighted intersection of potential songs in the song list with the user's musical preferences; (f) playing a preview of a first song in the master song list for the user and soliciting feedback from the user wherein the feedback options are selected from the group consisting of: (1) adding the song to the playlist and (2) not adding the song to the playlist; and (g) repeating the playing and selecting until the playlist is complete.

A first group of variations of the nineteenth aspect of the invention include, for example, one or more of (1) the feedback options consist of at least one additional feedback option selected from the group consisting of: (a) playing the preview again, (b) playing an extended preview of the song, (c) not adding the song to the playlist at this time but placing it on hold for potential inclusion in the playlist if no songs of more interest are previewed; (d) not adding the song to the playlist but leaving the song available for consideration when creating other playlists, and (e) not adding the song to the playlist and never presenting the song again to this user; (2) specifying the number of songs for inclusion in the playlist and determining when the playlist is full by comparing the number of songs placed in the playlist to the number of songs specified for inclusion; (3) the creating of the master song list further comprising retaining songs that the user has entered as favorites (e.g. either as coming from ta favorite artist or as a favorite song) regardless of other more general user preferences so long as the preferred songs are applicable to the desired playlist topic; (4) the creating of the master song list further comprises retaining songs that the user has entered as favorites (e.g. either as coming from ta favorite artist or as a favorite song) regardless of other more general user preferences but before such a favorite song is included in the playlist, the user is provided with a warning or notice that the favorite song does not have appropriate musical properties or lyrical properties for inclusion in the playlist, if such be the case, and the user is allowed to insert the song anyway; (5) the user is provided with an option to insert any song into a playlist, whether or not it meets the musical properties or lyrical properties associated with the playlist but prior to allowing such insertion the user is prompted with a warning or notice if the musical properties or lyrical properties of the song are inappropriate at which time the user may reject the song for inclusion or accept it for inclusion; (6) the producing of the master song list further comprises performing at least one additional weighted or non-weighted intersection of potential songs in the song list with at least one additional category of the user's musical preferences; (7) the song in the master song list are ranked according to one or more ranking categories prior to presentation of previews of the songs in the master song list to the user; (8) the playlist comprises multiple phases and wherein at least two of the phases are characterized by different musical properties (e.g. beat and meter, dynamics, harmony, key, musical instruments or voice, pitch, rhythm, tempo, texture, timbre, and/or the like) or lyrical properties (e.g. vocal message being conveyed); (9) the different musical properties or lyrical properties are limited to musical properties; (10) the different musical properties or lyrical properties include both musical properties and lyrical properties; (11) at least two of the musical or lyrical properties of the songs are used; (12) at least four of the musical or lyrical properties of the songs are used; and (13) at least six of the musical or lyrical properties of the songs are used.

In a twentieth aspect of the invention a method for creating a personalized purposeful purchase list of music, includes: (a) logging into an existing user account; (b) accessing previously entered preferences from a survey of music preferences; (c) entering a desired purchase list topic selected from a predefined group of functional topics; (d) accessing song information stored in a database wherein the database includes a plurality of songs with each song of said plurality identified with one or more purchase list topics (i.e. purposes) for which the song is considered applicable (e.g. by users that are members of a target culture) by the song's musical properties (e.g. beat and meter, dynamics, harmony, key, musical instruments and voice, pitch, rhythm, tempo, texture, timbre, and/or the like), its lyrical properties (e.g. vocal message being conveyed), or other properties; (e) creating a master song list by comparing an initial list of songs with at least two filtering functions wherein one filtering function comprises performing a weighted or non-weighted intersection of the potential purchase list songs with the desired purchase list topic and a second comprises performing a weighted or non-weighted intersection of potential songs in the song list with the user's musical preferences; (f) playing a preview of a first song in the master song list for the user and soliciting feedback from the user wherein the feedback options are selected from the group consisting of: (1) adding the song to the purchase list and (2) not adding the song to the purchase list; and (g) repeating the playing and selecting until the purchase list is complete.

A first group of variations of the twentieth aspect of the invention include, for example, one or more of (1) the feedback options consist of at least one additional feedback option selected from the group consisting of: (a) playing the preview again, (b) playing an extended preview of the song, (c) not adding the song to the purchase list at this time but placing it on hold for potential inclusion in the purchase list if no songs of more interest are previewed; (d) not adding the song to the purchase list but leaving the song available for consideration when creating other purchase lists, and (e) not adding the song to the purchase list and never presenting the song again to this user; (2) specifying the number of songs for inclusion in the purchase list and determining when the purchase list is full by comparing the number of songs placed in the purchase list to the number of songs specified for inclusion; (3) the creating of the master song list further comprising retaining songs that the user has entered as favorites (e.g. either as coming from ta favorite artist or as a favorite song) regardless of other more general user preferences so long as the preferred songs are applicable to the desired purchase list topic; (4) the creating of the master song list further comprises retaining songs that the user has entered as favorites (e.g. either as coming from ta favorite artist or as a favorite song) regardless of other more general user preferences but before such a favorite song is included in the purchase list, the user is provided with a warning or notice that the favorite song does not have appropriate musical properties or lyrical properties for inclusion in the purchase list, if such be the case, and the user is allowed to insert the song anyway: (5) the user is provided with an option to insert any song into a purchase list, whether or not it meets the musical properties or lyrical properties associated with the purchase list but prior to allowing such insertion the user is prompted with a warning or notice if the musical properties or lyrical properties of the song are inappropriate at which time the user may reject the song for inclusion or accept it for inclusion; (6) the producing of the master song list further comprises performing at least one additional weighted or non-weighted intersection of potential songs in the song list with at least one additional category of the user's musical preferences; (7) the songs in the master song list are ranked according to one or more ranking categories prior to presentation of previews of the songs in the master song list to the user; (8) the purchase list comprises multiple phases and wherein at least two of the phases are characterized by different musical properties (e.g. beat and meter, dynamics, harmony, key, musical instruments or voice, pitch, rhythm, tempo, texture, timbre, and/or the like) or lyrical properties (e.g. vocal message being conveyed); (9) the different musical properties or lyrical properties are limited to musical properties; (10) the different musical properties or lyrical properties include both musical properties and lyrical properties; (11) steps or operations to purchase the music in the purchase list; (12) steps or operations to purchase the music in the purchase list and wherein a user's account or songs located on one or more of the user's device are reviewed to determine whether or not the user already owns one or more of the songs on the purchase list and if so, the already owned songs may optionally be repurchased or copied from the user's already owned data into a common purchase list with the other songs on the song list thus providing the user with a complete purchase list while potentially only purchasing a portion of the songs on the purchase list; and (13) steps or operations to purchase the music in the purchase list and wherein the purchase of the songs on the purchase list comprises the payment of a purchase list fee and a per song fee.

In a twenty-first aspect of the invention, a method for creating a personalized purchase list of purposeful music, includes (a) logging into an existing user account; (b) accessing previously entered preferences from a survey of music preferences; (c) entering a desired purchase list topic selected from a predefined group of functional topics; (d) accessing song information stored in a database wherein the database includes a plurality of songs with each song identified by a plurality of its musical properties, lyrical properties, or other properties, which are selected from the group consisting of (1) mode (e.g. major or minor), (2) pitch (e.g. high, low, varying), (3) tempo (slow, fast, varying, beats per minute), (4) volume (e.g. soft or loud), (5) dynamics (e.g. changes in volume, rapidly, slowly, etc.), (6) sound (e.g. pleasant, harsh, consonant, dissonant), (7) rhythm (e.g. regular or smooth, irregular or rough), (8) harmony (e.g. simple, major, consonant, complex, dissonant), (9) melody (e.g. melodic direction, pitch contour, and melodic motion), (10) tonality (e.g. tonal-atonal-chromatic), (11) timbre (e.g. number of harmonics}, (12) articulation (e.g. staccato-legato), (13) amplitude envelope (e.g. round or harp), (14) musical form (complexity, repetition, new ideas, disruption, etc.), (15) interaction between these features; (16) lyrical subject matter of the song, (17) positive or negative movement of the lyrical subject matter; (18) cultural relevance of the lyrical subject matter of the song; and (19) age or generational relevance of the lyrical subject matter of the song; (e) creating a master song list by comparing an initial list of songs with at least two filtering functions wherein one filtering function comprises performing a weighted or non-weighted intersection of the potential purchase list songs based on one or more musical features of the songs or lyrical features of the songs with the appropriateness of those features for purposeful use in the desired purchase list topic and a second comprises performing a weighted or non-weighted intersection of potential songs in the song list with the user's musical preferences;(f) playing a preview of a first song in the master song list for the user and soliciting feedback from the user wherein the feedback options are selected from the group consisting of: (1) adding the song to the purchase list and (2) not adding the song to the purchase list; and (g) repeating the playing and selecting until the purchase list is complete.

A first group of variations of the twenty-first aspect of the invention include, for example, one or more of (1) the feedback options consist of at least one additional feedback option selected from the group consisting of: (a) playing the preview again, (b) playing an extended preview of the song, (c) not adding the song to the purchase list at this time but placing it on hold for potential inclusion in the purchase list if no songs of more interest are previewed; (d) not adding the song to the purchase list but leaving the song available for consideration when creating other purchase lists, and (e) not adding the song to the purchase list and never presenting the song again to this user; (2) specifying the number of songs for inclusion in the purchase list and determining when the purchase list is full by comparing the number of songs placed in the purchase list to the number of songs specified for inclusion; (3) the creating of the master song list further includes retaining songs that the user has entered as favorites (e.g. either as coming from ta favorite artist or as a favorite song) regardless of other more general user preferences so long as the preferred songs are applicable to the desired purchase list topic; (4) the creating of the master song list further comprises retaining songs that the user has entered as favorites (e.g. either as coming from ta favorite artist or as a favorite song) regardless of other more general user preferences but before such a favorite song is included in the purchase list, the user is provided with a warning or notice that the favorite song does not have appropriate musical properties or lyrical properties for inclusion in the purchase list, if such be the case, and the user is allowed to insert the song anyway; (5) the user being provided with an option to insert any song into a purchase list, whether or not it meets the musical properties or lyrical properties associated with the purchase list but prior to allowing such insertion the user is prompted with a warning or notice if the musical properties or lyrical properties of the song are inappropriate at which time the user may reject the song for inclusion or accept it for inclusion; (6) the producing of the master song list further comprises performing at least one additional weighted or non-weighted intersection of potential songs in the song list with at least one additional category of the user's musical preferences; (7) the songs in the master song list are ranked according to one or more ranking categories prior to presentation of previews of the songs in the master song list to the user; (8) .the purchase list comprises multiple phases and wherein at least two of the phases are characterized by different musical properties (e.g. beat and meter, dynamics, harmony, key, musical instruments or voice, pitch, rhythm, tempo, texture, timbre, and/or the like) or lyrical properties (e.g. vocal message being conveyed); (9) the different musical properties, lyrical properties, or other properties are limited to musical properties; (10) the different musical properties, lyrical properties, or other properties include both musical properties and lyrical properties; (11) the different musical properties, lyrical properties, or other properties include all three; (12) steps or operations to purchase the music in the purchase list; (13) steps or operations to purchase the music in the purchase list and wherein a user's account or songs located on one or more of the user's devices are reviewed to determine whether or not the user already owns one or more of the songs on the purchase list and if so, the already owned songs may optionally be repurchased or copied from the user's already owned data into a common purchase list with the other songs on the song list thus providing the user with a complete purchase list while potentially only purchasing a portion of the songs on the purchase list; (14)) steps or operations to purchase the music in the purchase list wherein the purchase of the songs on the purchase list comprises the payment of a purchase list fee and a per song fee; (15) at least two of the musical or lyrical properties of the songs are used; (16) at least four of the musical or lyrical properties of the songs are used; and (17) at least six of the musical or lyrical properties of the songs are used.

Twenty-second to twenty-sixth aspects of the invention include system or apparatus counterparts to the thirteenth to seventeenth aspects of the invention, respectively wherein system or apparatus counterparts are defined by means plus function elements

Twenty-seventh to thirty-first aspects of the invention , respectively, define system or apparatus counterparts to the thirteenth to seventh aspects of the invention wherein the elements are not defined using means plus function elements but are defined by structural elements that are configured or programmed to provide required functionality and functional relationships.

Thirty-second to thirty-sixth aspects of the invention, respectively, define system or apparatus counterparts to the thirteenth to seventh aspects of the invention wherein the elements are not defined using means plus function elements but are defined by structural elements in the form of electrical circuitry that is configured to provide to provide required functionality and functional relationships.

Further variations of the aspects of the invention are possible. For example, a variation set forth in association with one aspect of the invention may act as a variation of another aspect of the invention or even a variation of a variation of another aspect of the invention so long as the added variation does not completely eliminate the function of the original aspect, the original variation of the aspect, or variations of the aspect.

Further aspects of the invention will be understood by those of skill in the art upon reviewing the teachings herein. These other aspects of the invention may provide various combinations of the aspects presented above as well as provide other configurations, structures, functional relationships, processes, alternative ordering of steps from the example processes set forth herein, and uses that have not been specifically set forth above.

### BRIEF DESCRIPTION OF THE DRAWINGS

FIGS. 1A 1D provide block diagrams representing basic features of four embodiments of the invention wherein the music lists generated may be for playlists or for purchase lists.

FIG. 2 provides a schematic illustration of an example main display page and basic functionality of a web-based system (known, for example, as “Easy Rhythms”) that is capable of performing the playlist generation methods of some embodiments of the invention wherein the main page allows access to a variety of secondary pages that provide a desired level of functionality.

FIG. 3 provides a schematic illustration of an example general information secondary page that shows a number of possible options that may be selected to access a variety of topics of interest concerning the system.

FIG. 4 provides a schematic illustration of an example of account management functionality that allows a user to set up and modify an account as well as make payments and set optional preferences.

FIG. 5 provides a schematic illustration of an example of survey creation, data entry, and modification functionality.

FIG. 6 provides a schematic illustration of an example survey data entry page that allows entry of music preference information on a date range basis, a genre basis, a favorites basis, as well as under a number of additional categories that might be useful in creating master song lists for a user.

FIGS. 7A and 7B provide sample functionality for the creation of purposeful personalized playlists according to some embodiments of the invention. FIG. 7A provides a schematic illustration of example functionality for converting database songs to a master song list using a specified purpose or topic, data preference information, genre information, favorites information, and “do not play” information. FIG. 7B provides a schematic illustration of example functionality for converting master song list music into user selected playlist songs by playing previews and making selections.

FIG. 8A provides a schematic representation of a sample user interface screen as it might exist during the creation or modification of a standard or non-transitional playlist.

FIG. 8B provides a schematic representation of a sample user interface screen as it might exist during the creation or modification of a transitional playlist (i.e. a playlist that includes at least one transition from songs having one set of musical properties to songs having a different set of properties).

FIG. 9 provides a schematic representation of sample functionality that might be used during modification of a playlist.

FIG. 10 provides a schematic representation of sample functionality that might be used during the playing of a playlist.

FIG. 11 provides a schematic representation of a sample user interface that might be displayed during the playing of a playlist which includes the ability to select different options or even to drag and drop songs to change play order or temporally or permanently move songs from the hold category to a given playlist.

FIG. 12 provides a schematic representation of network communications (over the internet, a telephone network, or a television network) that may be involved in several different implementations of the methods of certain embodiments of the invention (e.g. operating under the name Easy Rhythms) wherein, for example, Easy Rhythms may be operated as an independent website, an Easy Rhythms website accessed by a third party website, or Easy Rhythms functionality embedded in a third party website.

### DETAILED DESCRIPTION OF PREFERRED EMBODIMENTS OF THE INVENTION

As used herein the term “song” is intended to have broader meaning than it may normally be given. As used herein song means any musical work or piece whether it be chanting, a cappella singing, singing with accompanying instrumental music, instrumental music without singing (e.g. orchestral pieces, marching band, piano, guitar, rhythmic percussion), sounds of nature (e.g. rain, wind, running water, ocean waves), animal sounds (e.g. sounds from a whale or bird), classical, modern, or the like. When used herein, if it is intended that a narrower meaning apply, the term song will be accompanied by one or more appropriate adjectives (e.g. vocal song—a song comprising human vocalization; instrumental song—song comprising instrumental sounds; and an instrumental-only song or a non-vocal song—a song with instrumental sounds but without vocal accompaniment). Song as used herein may refer to an entire musical work or piece or it may refer to a portion of that work or piece that is of interest in a given circumstance.

Embodiments of present invention provide unique methods and systems for a user to enjoyably and rapidly create purposeful and fully personalized playlists or lists of songs to be purchased. For some purposeful topics, a user may benefit from a simple list of songs that have musical and/or lyrical content that is appropriate for that purpose wherein each song that is in the playlist is selected (e.g. previewed and selected) by the user for inclusion in the list. For other purposes, or for a more enhanced effect, a user may benefit from a playlist that includes musical and/or lyrical content that include transitions within the playlist one or more times (e.g. wherein the user previews and selects the specific songs to be included in each transitional level).

For example, an exercise playlist may, in some circumstances, benefit from a warm up phase that includes moving but not overly energetic pieces of music, followed by a workout phase that includes music with a rhythm or other musical properties appropriate for a steady, or varying, and appropriately energetic pace, which in turn may be followed by a cool down phase of music with a progressively decreasing pace. In some embodiments transitional phases may be added or deleted as appropriate or even adjusted during the playing of the playlist. In some embodiments, during playing of the playlist, feedback from the user might be used to adjust the upcoming music selections. Such feedback may be in the form of user provided selections (e.g. pause the playlist, cut the playlist short, extend the playlist, extend or shorten the current playlist or upcoming playlist level) or in the form of bio-metric data read from one or more sensors monitoring the user (e.g. pulse rate, breathing rate, oxygen level, blood pressure, etc.). In some embodiments only one transition may be used while in other embodiments two, three, or more transitions may be included in particular playlists for particular topics. Another example of a playlist that might include transitions is a mood enhancing playlist (one intended to move a user from a depressed or sad state to a happier or more hopeful state) that starts with one or more songs that tend to match an initial mood of the user (e.g. have musical or lyrical properties) and then transition through one or more levels or phases to songs having more upbeat, energetic, joyful, or hopeful musical and/or lyrical properties. In some implementations, a user could create multiple playlists that each start with music having different levels of relative melancholy and then transition through one or more phases to a desired level of musical elevation (e.g. energy, joy, etc.). When a user wants some up-lifting, the playlist with the appropriate starting level may be selected depending on the user's mood at that time. Transitions may also be used with other playlist topics as appropriate, e.g. a relaxation playlist may start with some tension and then progress to music with a desired and calming set of musical properties, a memory playlist may start with youthful music and work up to music related to later periods of life, and alternative memory playlist may start from a later period of life and progress to earlier periods of life. In all embodiments, a user selects the playlist topic but in some implementations a user might have multiple transitional variations from which to choose while in other variations more advanced users may select their own transitional effects for a given playlist. In some implementations, a user may have the option of changing subsequent elements or phases of a playlist while it is being played.

When playing playlists, the duration of playing may be set in a variety of manners, e.g. from start to finish, for a specified duration which may be shorter or longer the complete playlist length, for a specified duration for each of the different phases of the playlist, for the entire lengths of a plurality of playlists to be played in a desired order, or for a set period of time for each of a plurality of desired playlists. Playlists may be started upon a user's command or based on a schedule (e.g. like an alarm clock or reminder feature on a phone or computer). In some variations, users may start a playlist but have the ability to end the playing of it early by skipping intermediate songs but playing one or more ending songs or by playing the intermediate songs but skipping one or more ending songs.

With some songs, musical properties may change and such changes may be beneficial for some playlist topics while for other topics such changes may be inappropriate and thus, for some topics, songs may be divided into smaller sections wherein the smaller sections will become parts of specific playlists without the whole song becoming part of the playlists.

In some alternative embodiments, additional information may be used in creating playlists, in playing playlists, and/or in setting the duration of different play list phases. For example, pulse rate may be monitored, blood pressure may be monitored, brainwave information may be monitored, tremor rate monitored, or any other of a number of physiological parameters monitored. Such monitoring may be useful in the process of playing songs and adjusting play duration or play order to maintain a desired physiological response (e.g. pulse rate within a target range) or mental state (within a desired range). Such monitoring may be useful in the initial process of previewing songs where feedback or recommendations to a user may be provided or even decisions about which songs or which types of songs may be most effective such that preview order may be varied to more quickly provide the user with appropriate playlist songs. Such monitoring, for example, may be provided by optical, inductive, capacitive, resistive sensing, or the like, and may be provided with or without physical contact, using wired or wireless transmission to a control unit.

In some embodiments, playlists may be made to include voice recordings made by the user or by others wherein the voice recording may provide messages, encouragement, affirmations, goal reminders, and the like that may help the user achieve goals that he or she is seeking. Such recordings may include instruction sets that the user is to follow to help the user achieve a desired state of being or receptiveness to suggestions. Such recording may be most useful in combination with relaxing, calming, sleep, or awake up playlists but they can be used with any playlists so long as the message is appropriate for the purpose. In some embodiments, the messages played may be keyed to physiological or mental states that are currently being monitored.

According to various embodiments of the invention, numerous playlist topics are possible and include, for example:

(1) Exercise:
a. Single phase Easy (e.g. pulse rate 80-100)
b. Single phase Moderate 1(e.g. pulse rate 100-120)
c. Single phase Moderate 2 (e.g. pulse rate 120-140)
d. Single phase Advanced (e.g. pulse rate 140-160)
e. Single phase Extreme (e.g. pulse rate 160-180)
f. Multiphase starting with a warm up, followed by a single aerobic phase at a desired pulse rate range, and then followed by a cool down
g. Multiphase starting with a warm up, followed by multiple aerobic phases within varying desired pulse rate ranges, and then followed by a cool down
h. Single or multi-phase playlist with song-selection based at least in part on a monitored physiological parameter (e.g. pulse rate) which is being monitored and a current or future target value for that parameter resulting in changes to selection of future songs or song variations (e.g. same song but played at different tempos)

(2) Mood Enhancement
a. Single phase Upbeat & energetic
b. Multiphase starting with a moderate melancholy phase, then transitioning to a mildly melancholy phase, moving to a neutral phase, then an upbeat phase, and finally ending up in an upbeat and energetic phase
c. Multiphase starting with a mildly melancholy phase, then a neutral phase, an upbeat phase, and finally an upbeat and energetic phase
d. Multiphase starting with a neutral phase, an upbeat phase, and finally an upbeat and energetic phase.

(3) Focus & Concentration
a. Single phase
b. Multi-phase

(4) Dance
a. Slow
b. Moderate
c. Fast

(5) Relaxation or Peacefulness
a. Single phase
b. Multi-phase with an initial slightly tense phase followed by a calming or relaxing phase
c. Multi-phase with a calming or relaxing phase followed by a more energetic phase to ease the user back to a more active state
d. Multi-phase with an initial slightly tense phase followed by a calming or relaxing phase followed by a more energetic phase to ease the user back to a more active state

(6) Wake Up
a. Single phase
b. Multiphase with one or more calmer or quieter phases followed by one or more more energetic or louder phases

(7) Energizing
a. Single phase moderate energy
b. Single phase high energy
c. Multiphase with build up from low energy to high energy
d. Falling Asleep
e. Single phase
f. Multiphase Starting with slightly more energetic songs and transitioning to calmer and quieter songs

(8) Strength and Courage
a. Single phase
b. Multiphase Starting with songs that are potentially more melancholy and transitioning to songs that are more culturally courageous or transitioning to songs relevant to the individual at a certain period of his/her life when they were strongest, most in control, etc.

(9) Pain Relief
a. Single phase Music that can capture and hold the mind's attention and can help calm and relax
b. Multiphase

(10) Memory Enhancement
a. Single phase songs that have particular meaning to the user for a given period of time relevant to the memories that they want to enhance or recall
b. Multiphase staring with songs when the user was young and moving up to later stages of life
c. Multiphase staring with songs from later stages of life and moving backward to early stages of life

Numerous other purposeful playlists are possible and may be single phase or multiphase in nature, they may be limited to music to be listened to, they may include music to be sung, they may include music to move to, they may include non-musical elements such as affirmations, goals, etc. More information about playlist topics, purposes, and relevant music for different purposes may be ascertained from various sources including “The Tao of Music: Sound Psychology” by John M. Ortiz, PH.D, published by Samuel Weiser, York Beach Me. This referenced book is incorporated herein by reference as if set forth in full herein. Characterization of songs for each topic or topic phase that will be included in any specific database implementation of the various embodiments of the invention are well within the capability of the art and may be made qualified psychologists, music therapists or other music professionals. Additional information about music, musical properties, and the like can be found in various books, recordings, etc. For example more information may be found in a course by The Great Courses Company, entitled “Understanding the Fundamentals of Music”, by Robert Greenberg, copyright 2007 by the Teaching Company or in the book “How Music Works: The Science and Psychology of Beautiful Sounds, from Beethoven to the Beatles and Beyond” by John Powel, published by Little Brown Company, New York, N.Y., copyright 2010. A mood based classification system is proposed and evaluated by Owen Craigie Meyers in a paper entitled “A Mood-Based Music Classification and Exploration System” submitted in partial fulfillment of the requirements for the degree of Master of Science in Media Arts and Science at the Massachusetts Institute of Technology June 2007. Each of these referenced works is incorporated herein by reference as if set forth in full.

According to Meyers: The following definitions/descriptions are given to musical features:
Mode is a set of musical notes forming a scale and from which melodies and harmonies are constructed. Major modes are often associated with happiness, gracefulness and solemnity while minor modes being related to the emotions of sadness, dreaminess, disgust, and anger.
Harmony is the combination of simultaneously sounded musical notes to produce chords and chord progressions having a pleasing effect. Simple harmonies or consonant chords, such as major chords, are often pleasant, happy, and relaxed. Complex harmonies contain dissonant notes that create instability in a piece of music and activate emotions of excitement, tension, anger, and sadness.
Tempo is defined as the speed at which a passage of music is or should be played and is typically measured in beats per minute. A fast tempo falls in the range of 140 to 200 beats per minute while a slow temp could be anywhere between 40 and 80 beats per minute. Fast tempos are generally considered lively and exciting, while slow and sustained tempos are majestic and stately. Depending on other musical factors, a fast tempo can trigger such emotions as excitement, joy, surprise, or fear. Similarly, a slow tempo is typical of calmness, dignity, sadness, tenderness, boredom, or disgust.
The definition of rhythm with respect to emotion is not consistent among various authors, but the most common distinctions include regular/irregular, smooth/rough, firm/flowing, and simple/complex. Rhythm is officially defined as the systematic arrangement of musical sounds, principally according to duration and periodic stress. The features proposed by researchers suggest that variations of the regularity or complexity of a rhythmic pattern in a piece of music trigger emotional responses. Regular and smooth rhythms are representative of happiness, dignity, majesty, and peace, while irregular and rough rhythms pair with amusement, uneasiness, and anger.
Loudness relates to the perceived intensity of a sound, while dynamics represent its varying volume levels. The dynamics of a piece of music may be either soft or loud. A loud passage of music is associated with intensity, tension, anger, and joy and soft passages are associated with tenderness, sadness, solemnity, and fear. Large dynamic ranges signify fear, rapid changes in dynamics signify playfulness, and minimal variations relate to sadness and peacefulness.
Other features that convey emotional responses include pitch (high-low), intervals, melody (melodic direction, pitch contour, and melodic motion), tonality (tonal-atonal-chromatic), timbre (number of harmonics}, articulation (staccato-legato), amplitude envelope (round-sharp), musical form (complexity, repetition, new ideas, disruption, etc.), and interaction between factors.

In various embodiments, a database of songs is provided wherein the songs or song fragments in the database are categorized by one or more identifying attributes such as their artists, the song names, etc. They are also preferably characterized by their periods, their genres (maybe more than one for any given song), and their musical applicability to each of a variety of potential playlist topics and topic phases. In the database some songs may also have lyrics and/or karaoke-type word highlighting to aid a listener in singing along with the songs when they are watching a user display. Some songs may include album information, version information, live performance, or studio performance information, etc. Some songs may include language translation or transliteration information to aid a user in making specific music requests. Some songs may also include cultural identification information, sensitive or explicit content or language indications, and the like. Any of these characterizations may be used in combinations with a user's preferences when creating one or more master song lists that will be used for selection or preview possibilities when creating a playlist or purchase list based on a specified topic (e.g. one master song list for a standard playlist and multiple master song lists for playlists with one or more transitions). In some embodiments, multiple phases of a multiphase playlist may utilize songs of similar musical characteristics and as such a portion of the phases (e.g. two of the three or more phases) may be created using a single master song list.

In some embodiments, the database associates with each song its perceived relevance or lack of relevance for each of a variety of topics or phases of topics. In some embodiments, these designations or relevancy determinations may be made by psychologists, music therapists, other music professionals, analysis of opinion based survey information or physiological response based survey information. In some embodiments designations and or relevancy determinations may be made by automatic computer based analysis and processing. In other embodiments, instead of associating topic relevance with each song, musical or lyrical features of each song may be determined (e.g. by a professional, by analysis of survey results, or by automatic computer processing) and stored in one part of the database while another part associates playlist topic or playlist topic phase information with musical or lyrical features that are most appropriate to the topic, neutral to the topic, and/or contrary to the topic. In either event, upon selection of the topic, correlations can be made between songs in the database and the topic to generate preview lists that are limited to songs having appropriate musical and/or lyrical features for effective use in a playlist or purchase list should they be of interest to the user.

The automatic computer processing to provide designations or relevancy determinations or to extract musical or lyrical features of songs may occur in a variety of ways. Examples of such methods are discussed in (1) “Automatic Music Classification with jMIR”, by Cory McKay, January 2010, a thesis submitted to McGill University in partial fulfillment of the requirements of the degree of Doctor of Philosophy”; (2) “Automatic Classification of Musical Mood by Content-Based Analysis”, by Cyril Laurier, 2011, a dissertation submitted to the Department of Information and Communication Technologies of Universitat Pompeu Fabra; (3) “Automatic Mood Classification for Music”, by P. W. M. Kanters, June, 2009, HAIT Master Thesis Series nr 09-001, Tilburg Centre for Creative Computing, Tilburg University, The Netherlands; (4) “Improving Music Mood Classification Using Lyrics, Audio, and Social Tags, by Xiao Hu, 2010, a dissertation for degree of Doctor of Philosophy in Library and Information Science, University of Illinois at Urbana-Champaign; and (5) the paper by Craigie Meyers referenced above. Each of these referenced papers is incorporated herein by reference as if set forth herein in full.

During creation of some playlists or purchase lists, a specific user may provide, and the system (i.e. a single apparatus, combination of networked apparatus, or a combination of co-functioning machine parts) may utilize, the user's current general musical preferences, the user's musical preferences at different times of his or her life, or default musical preferences associated with his or her age, gender, or other personal attribute which has been entered into the user's profile in the system; however, during creation of other playlists, the user may set up general preferences for other family members or friends, make playlist topic selections, and then run through the preview and selection process so that another person may benefit from the resulting playlist or purchase list. This may provide a way of making customized gifts or may be used to provide benefits to those that may no longer be able to provide such benefits to themselves (e.g. people suffering from memory loss, senility, depression, or the like. Such efforts may be shared with others by sending CDs containing playlist songs, downloading playlist songs to portable electronic devices, or by simply forwarding playlist access information to the intended recipient, etc.

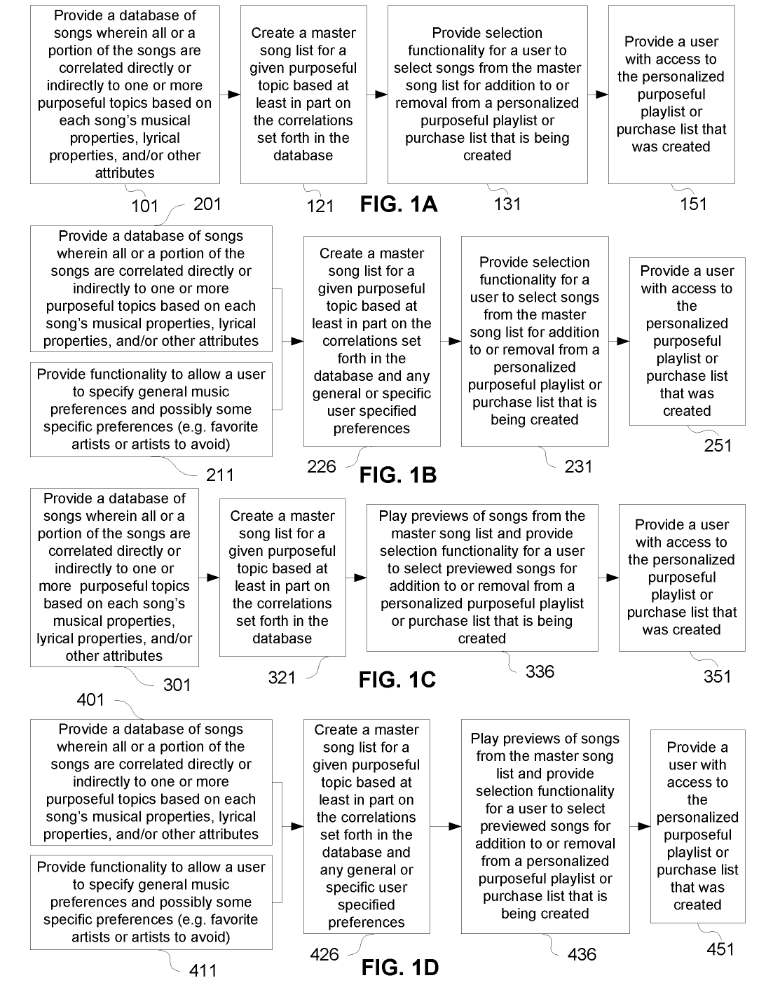

FIGS. 1A-1D provide block diagrams representing basic features of four groups of embodiments of the invention wherein the music lists generated may be for playlists or for purchase lists.

FIG. 1A provides a block diagram including four elements. Block 101 calls for the provision of a database of songs wherein all or a portion of the songs are directly or indirectly correlated to one or more purposeful playlist or purchase list topics wherein such correlation is based on each song's musical properties, lyrical properties, and/or some other known relevance (e.g. cultural significance). In some variations this correlation may simply be binary, i.e. yes or no, while in others it may be a weighted value such as 0%-100% depending on the musical or lyrical properties alone or dependent on cultural or other attributes that have come to be socially associated with the song (e.g. the relevance of The Star Spangled Banner to citizens of the United States of America). In some variations the correlation of songs to topics may be direct (i.e. the database holds the correlation or correlation value with all other data associated with the specific song). In other variations, the correlations may be indirect (i.e. derivable from information stored directly with the songs, such as tempo, rhythm, harmony, and the like with other information not specifically associated with the songs, for example known relevance of attributes such as tempo, rhythm, harmony and the like to the topic of interest). Indirect correlation methods may be more useful when adding in new playlist topics to the system as these topics need not be correlated directly to individual songs but only to attributes that have been ascertained as being associated with different songs. In still other variations a combination of direct and indirect correlations may be used (e.g. if a direct correlation exists in the database it may be used but if it does not exist, the song may still be correlated if it contains appropriate attributes).

Block 121 calls for the creation of a master song list for a given purposeful topic based at least in part on the correlations set forth directly or indirectly in the database.

Block 131 calls for the providing a user with functionality to select songs from the Master Song List that the user would like to include in a personalized purposeful playlist or purchase list that he or she is creating. In some alternative embodiments, a less personalized playlist may be obtained by the system (i.e. algorithms in the system) simply selecting a number of songs from the master song list for inclusion in the playlist or purchase list. It is anticipated that such system selected playlists or purchase lists will be less personal and thus potentially less effective for desired purpose (at least for some individuals). In some variations, the user may select a portion (e.g. a plurality but not all) of the songs to be included in the playlist while the system will select some songs for inclusion to complete the playlist or purchase list. Such variations may have the disadvantage of being less personalized but may have the advantage of introducing the user to new songs for which an interest may be developed as well as the advantage of leading to faster purposeful playlist or purchase list generation.

Block 151 calls for providing a user with access to the personalized purposeful playlist or purchase list that he or she has created or which has been created for him or her. This providing may be in the form of providing access to the music over the internet or over another network connection, providing for the purchase and downloading of the music, creating and shipping CDs, memory cards or music storage media to the user.

Each of these blocks may represent one or more elements of an apparatus or system that provides or enables playlist or purchase list generation; however, on the other hand each of these elements may provide one or more steps or operations undertaken during a method involving in the generation of playlists or purchase lists. In variations of the embodiments of this group additional elements or operations may be added as will be clear from the teachings set forth in this specification as a whole.

FIG. 1B provides a block diagram including two initial elements and a total of five elements. Block 201, like block 101 of FIG. 1A, provides a database of songs wherein all or a portion of the songs are correlated to one or more playlist topics based on the songs' musical and/or lyrical properties. Variations and alternative noted in association with block 101 also apply to block 201.

Block 211 provides for functionality that allows a user to specify (e.g. input to the system) general music preferences (e.g. the user generally likes baroque music but generally doesn't like hard rock) and possibly some specific preferences (e.g. favorite artist(s) or artists to avoid) that may be used by the system to provide music selections that are initially more focused on the user tastes.

Block 226 calls for the creation of a master preview list for a given purposeful topic based at least in part on the correlations set forth in the database and any general or specific user specified preferences. The songs in the master preview list not only meet the musical, lyrical, and/or other attributes required or desired for the purposeful topic but also are correlated to the user's general preferences such that the songs that the user will select from for inclusion in a playlist or purchase list will be of a reduced number and of higher overall interest to the user. This can lead to a system that provides a more rapid, enjoyable and effective playlist or purchase list generation process.

Block 231, like block 131 of FIG. 1A, provides for selection functionality for a user to select songs from the master song list for addition to or removal from a personalized purposeful playlist or purchase list (for the topic) that is being created. Similar variations and alternatives to those noted for block 131 also apply to this block.

Block 251, like block 151 of FIG. 1A, provides system functionality to a user to allow access to the personalized purposeful playlist or purchase list that was created by the user. Similar variations and alternatives to those noted for block 151 also apply to this block. Similar variations and alternatives noted in association with the overall system or method of FIG. 1A also apply to the system or method, respectively, of FIG. 1B

FIG. 1C provides a block diagram including a total of four elements. The system or process of FIG. 1C is similar to that of FIG. 1A in that elements 301, 321, and 351 provide the same functionality as 101, 121, and 151. The difference is that element 336 provides enhanced selection functionality compared to that of element 131. Element 336 provides for the playing of previews of songs from the master song list and providing selection functionality for a user to select songs based on the previews that were provided. As with block 131, the selection process may include the addition of songs to or removal of songs from a personalized purposeful playlist or purchase list that is being created. The variations and alternatives noted for block 131 may apply to block 336 mutatis mutandis.

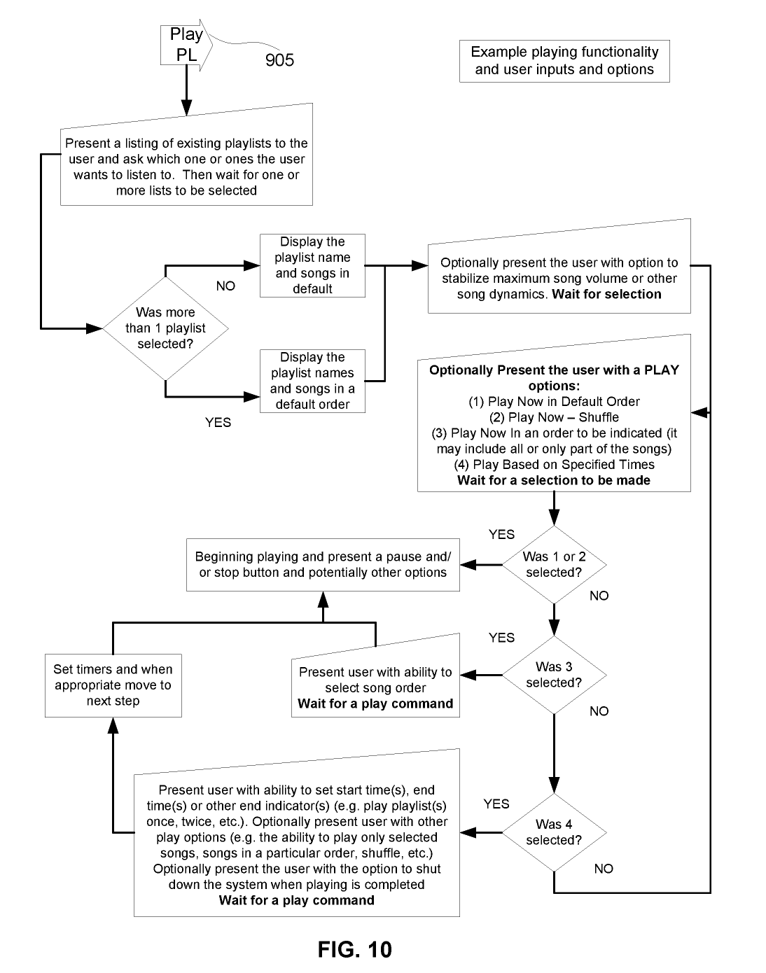

FIG. 1D combines some of the features of the systems or processes of FIGS. 1B and 10. FIG. 1D includes database (block 401) and general user preference specification (block 411) similar to that provided by blocks 201 and 211. It provides for creation of a master song list (block 426) similar to that of block 226 by combining the database, topic, and general preference information. Like the selection process of FIG. 1C (block 336), the selection process of FIG. 1D (block 436) provides for previewing of songs from the master song list to aid the user in making personalized, well informed selection decisions. Like blocks 251 and 351, block 451 provides for the user having access to the personalized, purposeful playlist or purchase list that was created.

Similar variations and alternatives to those noted for blocks 131 and 231 apply to blocks 336 and 436. Similar variations and alternatives to those noted for blocks 151 and 251 apply to blocks 251 and 451. Similar variations and alternatives noted in association with the overall systems or methods of FIG. 1A and 1B also apply to the systems or methods, respectively, of FIGS. 1C and 1D.

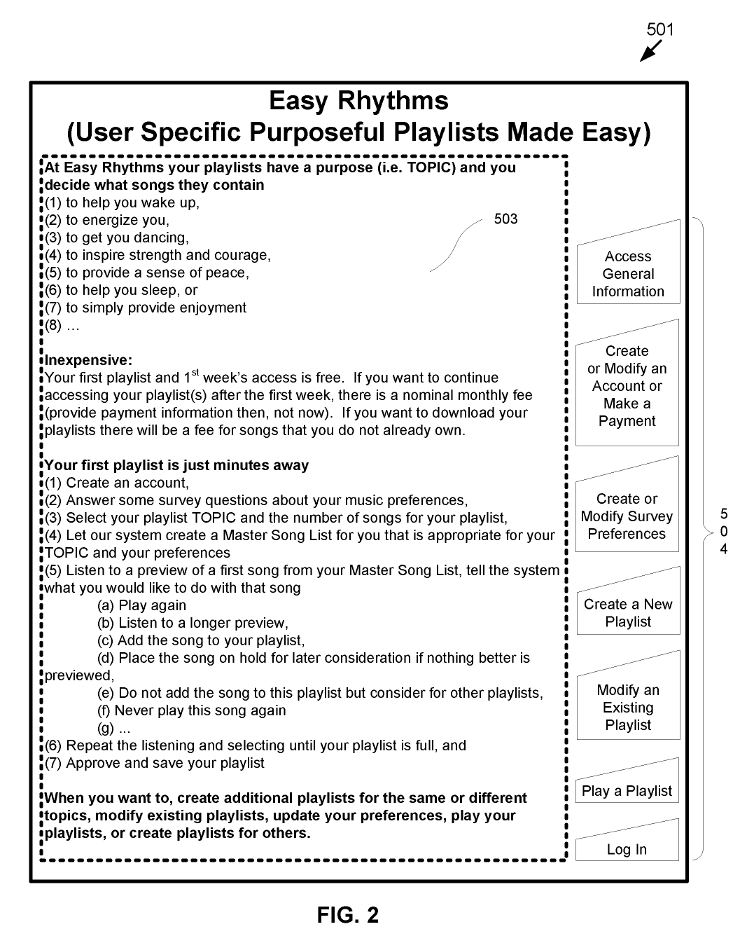

FIGS. 2-12 provide a specific example and variations of a system, and method of use of the system, for creating playlists according to the embodiment of FIG. 1D with enhancements to provide further functionality (playing of playlists, purchase of songs, creation of multiple playlists, modification of playlists, and the like). The example of FIG. 2 12 and its alternatives can apply to the creation of purchase lists as well as playlists. It is also understood that numerous variations, beyond those noted explicitly herein will become apparent to those of skill in the art upon review of the teachings herein.

FIG. 2 provides a schematic illustration of an example main display page 501 and a basic functionality description 503 of a web-based system (known generically herein as “Easy Rhythms”™) that is capable of performing an example of the playlist generation method of FIG. 1D and enhanced playing methods associated with some embodiments of the invention wherein the main page allows access to a variety of secondary pages 504 by clicking on buttons such that a desired level of additional functionality can be obtained. In other system implementations, other functionality, pricing structures, user interaction screens may exist as opposed to the example of 503. In the example of FIG. 2, seven buttons are provided to provide access to additional menus or interface screens or functionalities. In other embodiments, different numbers of buttons and types of information access may be made available. In some embodiment variations, the playlist or purchase list generation and playback functionality may be implemented via interfaces other than that of a web page. For example, such functionality may be implemented as part of a Cable TV on demand type service, a smart phone app, a game system program, or other computer program or hardwired device capable of accessing needed information from a network.

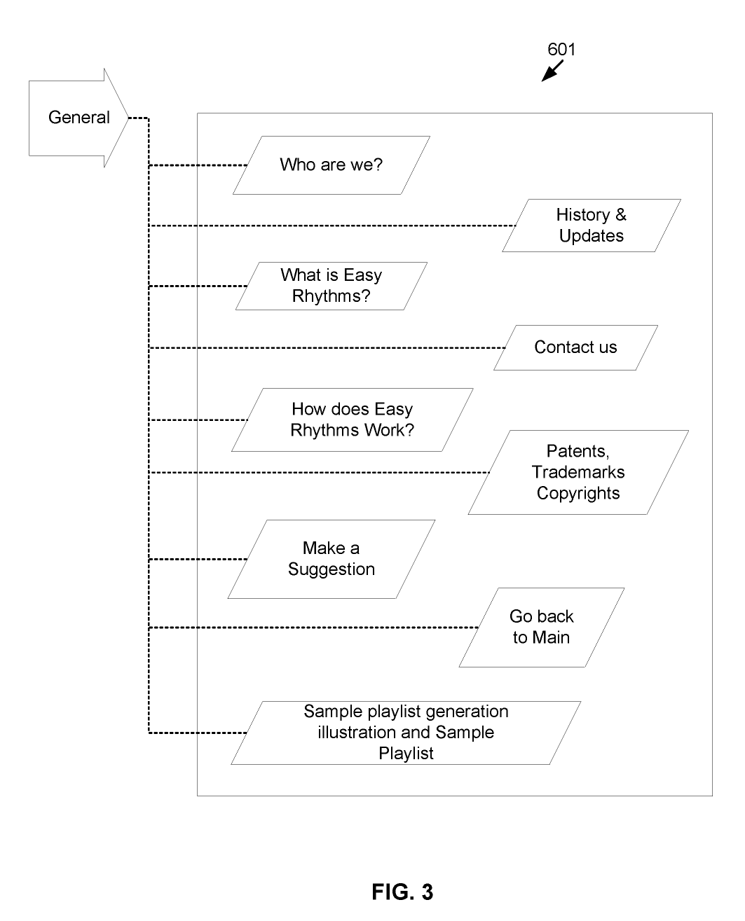

FIG. 3 provides a schematic illustration of an example general information secondary page 601 that shows a number of possible options that may be selected to access a variety of topics of interest (9 different topics in the example as shown) concerning the system. Each button Various example categories of information are presented on this figure and in actual implementation pressing one of the button would lead a user to one or more tertiary pages where further information would be available.

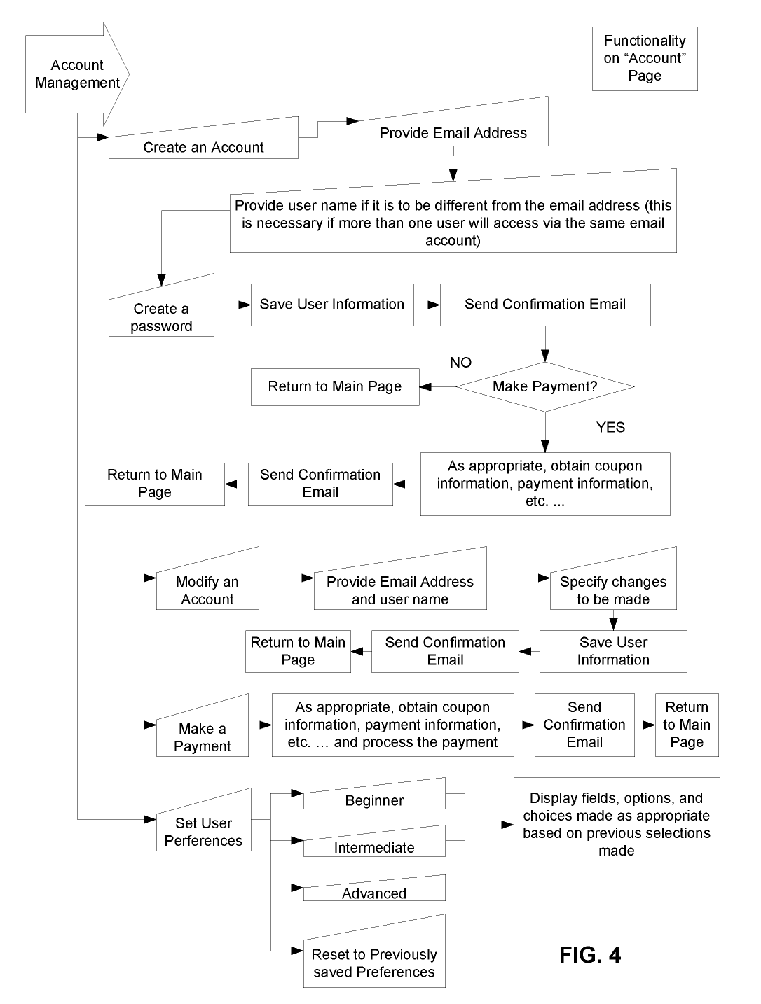

FIG. 4 provides a schematic illustration of an example of account management functionality that allows a user to create an account, modify an account, make payments, and set optional preferences. This functionality may be accessed from the second 504 button of FIG. 2. This functionality would of course be provided along with an appropriate user interface (no shown). The selection of the optional preferences, in actual implementation, would bring up tertiary pages or dialog boxes that might allow some users to gain more control of their Easy Rhythms environment and even functionality (e.g. by expanding or decreasing master song list filtering functionality). Some users might like such added control while others might be confused or hindered by it (e.g. inexperienced users or even experienced users that just want a simple interface environment may not want a nuanced access.

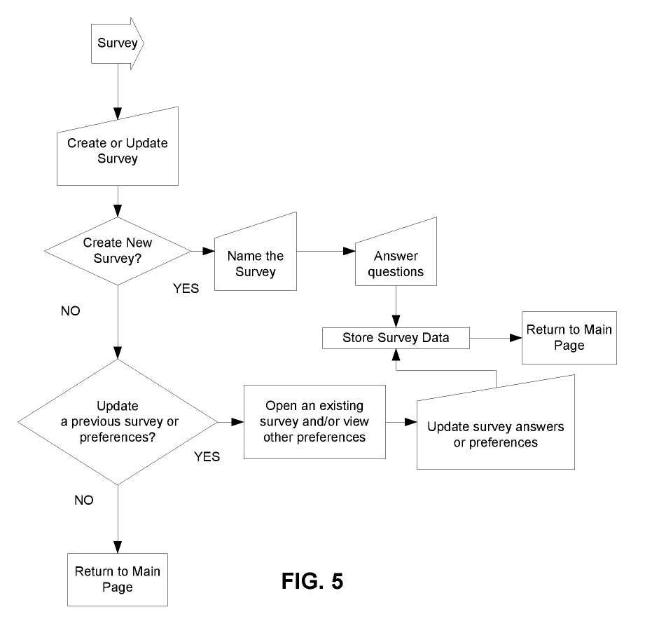

FIG. 5 provides a schematic illustration of an example of survey creation, data entry, and modification functionality. This functionality might be accessed, for example by clicking on the third button 504 of FIG. 2.

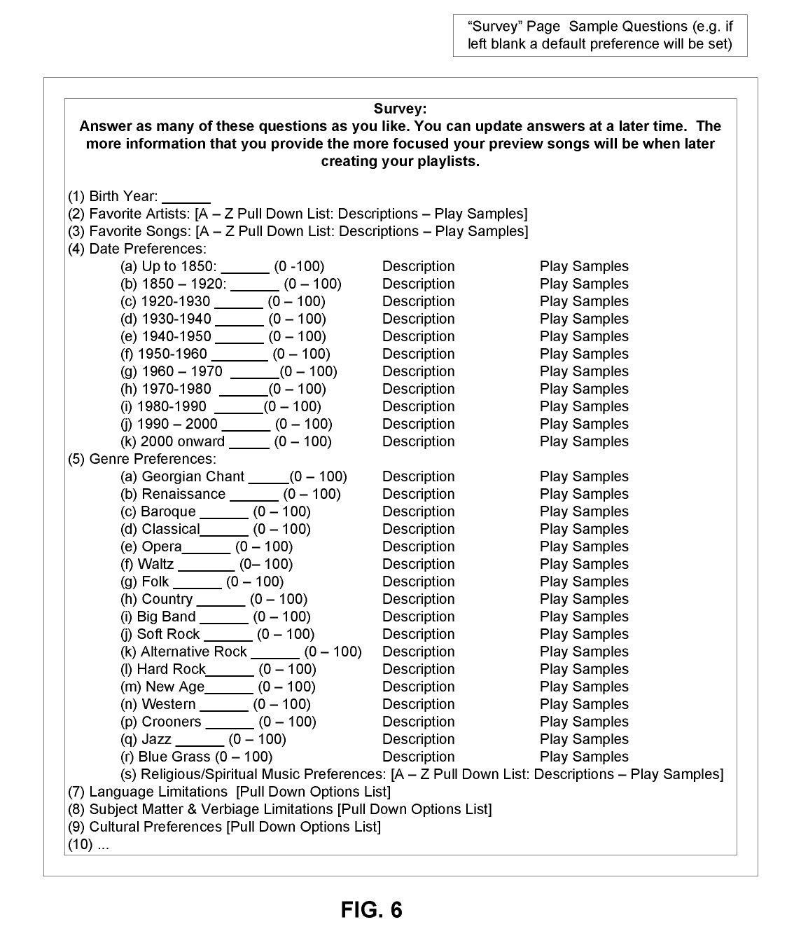

FIG. 6 provides a schematic illustration of an example survey data entry page that allows entry of music preference information on a date range basis, a genre basis, a favorites basis, as well as under a number of additional categories that might be useful in creating master song list for a user. In some alternative embodiments many additional or more specific genres or subgenres or styles may be made available. Some users may have different preferences for different genres, or periods, based on particular playlist topics and as such, in some embodiments options may be made available that would allow the user not only to set an overall preference for a period or genre of music but further to set preferences on a topic-by-topic basis, e.g. via a pull down menu that would allow either yes-no selections by topic or possibly even weighted numerical preferences on a topic-by-topic basis. In some variations, if survey preferences are not given for some categories, their associated preferences will be judged to be very low or even zeros. In other embodiments, unanswered questions may just be given a fixed default value such as 25% or 50%. In still other embodiments, the default values may be set after examining the user's responses to the questions that were answered operating under the assumption that the user is ambivalent about or lacks an understanding of the category for which no answers were provided. if the only ranking given were all in the same range, then those probably represent high or low rankings and thus the unanswered questions should be given values around ½ of the value of the high rankings or several times the value of the lowest rankings. On the other hand, if some questions were answered with high values and others answered with low values, the unanswered questions probably represent unknowns and should receive answers intermediate to the ones given. In some embodiments, options may be provided allowing specification of a preference as “unknown” thereby allowing unanswered questions to be rated even lower. As indicated in the example of FIG. 6, categories may have samples associated with them that may be previewed by the user (i.e. listened to) in order to help the user select his or her initial preference level for that category. In some embodiments, after a history of playlist generation has occurred based on user selections made, the system may use knowledge gained to recommend changes to a user's general preferences.

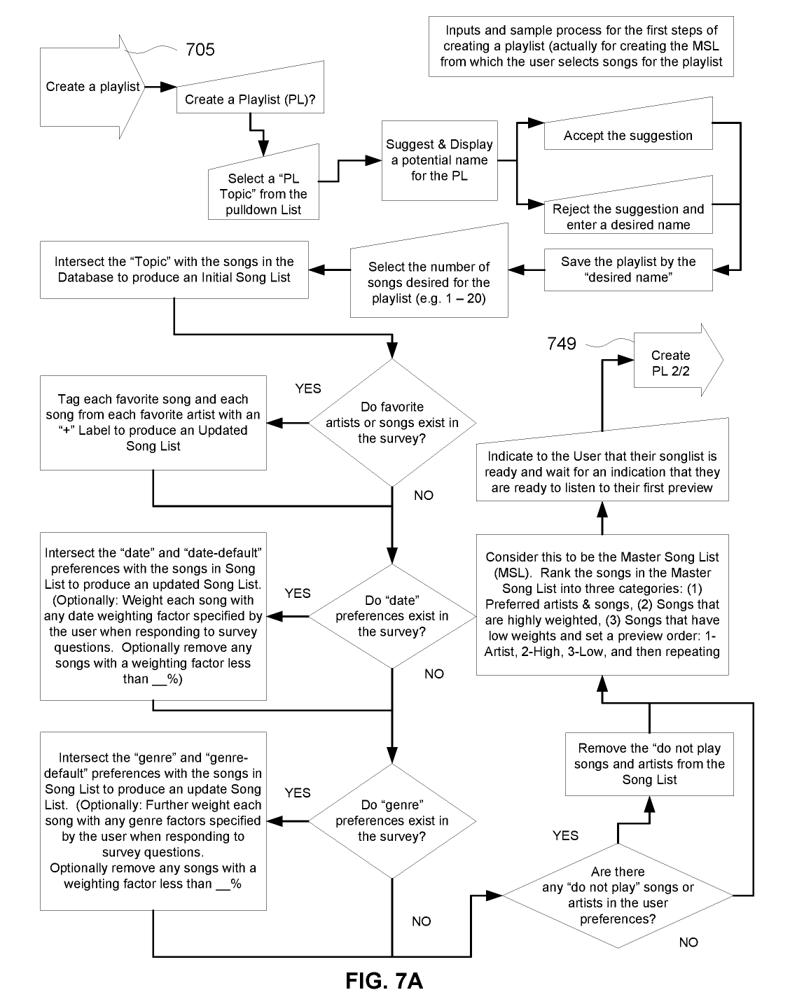

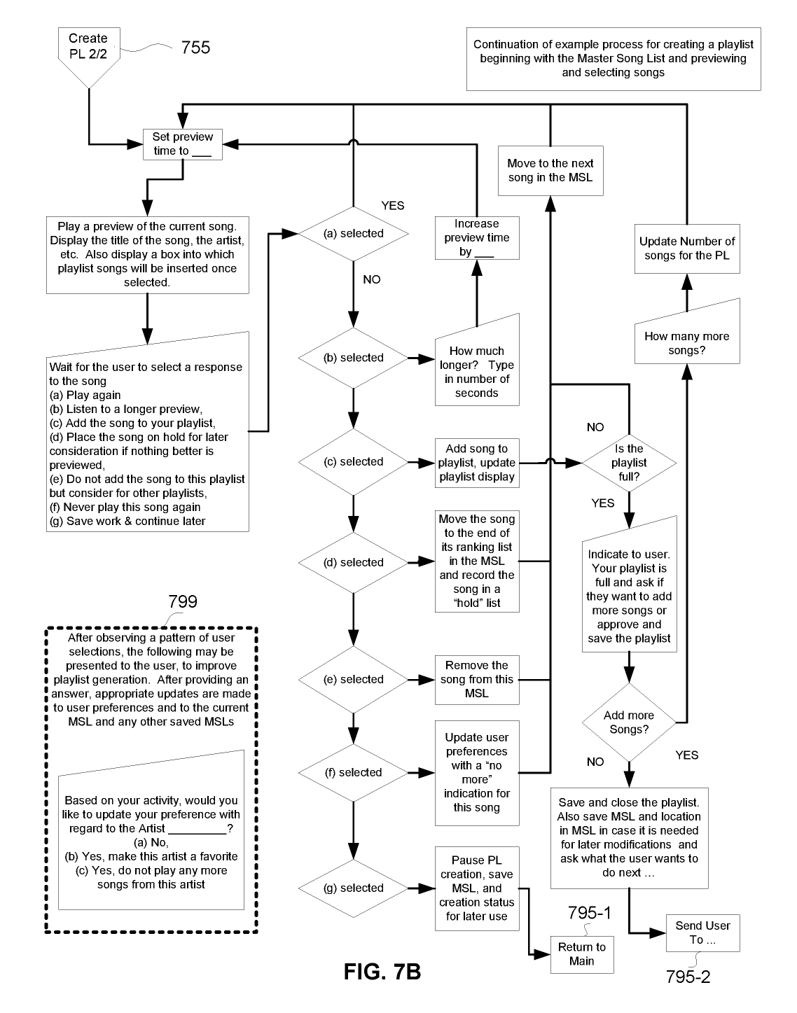

FIGS. 7A and 67B provide functionality for the creation of purposeful personalized playlists according to some embodiments of the invention. FIG. 7A provides a schematic illustration of example functionality for converting database songs to a master song list using a specified purpose or topic, data preference information, genre information, favorites information, and “do not play” information. The process starts with block 705 and ends with block 749 which rolls processing over to FIG. 7B starting with block 755 which is the marker for the operations of FIG. 7A and ends at either block 795-1 or 795-2 depending on whether creation of the playlist is paused or completed. FIG. 7B provides a schematic illustration of example functionality for converting master song list music into user selected playlist songs by playing previews and making selections. In alternative embodiments alternative orders of processing, filtering, intersecting, or weighting of database information with preferences is possible. In the illustrated embodiment database information is first intersected, filtered, or weighted by topic, then tagged favorites, and then intersected, filtered, or weighted by period, the by genre, and then finally by drop/do not play indications. In other embodiments all other orders for performing these filtering, intersections, weighting are possible and contemplated herein. For example, genre may be the first category to be used, then period, then favorites tagged, drops processed and finally topic filtering intersections or weightings performed. In some embodiments, fewer categories may be used in processing preferences. In some embodiments, additional categories may be used in processing preferences such as with regard to acceptability of explicit language or song topics, cultural preferences, language restrictions, relative popularity of a song within a given culture (e.g. Kyu Sakamoto's 1963 Japanese version of Sukiyaki in America). As shown in FIG. 7B, block 799, based on past user selections the system may attempt to predict future user preferences and may ask the user to confirm or reject system recommendations that are derived from such analysis. As indicated, Artist selections may be noted and recommendations given to the user to make the artist a favorite or to complete drop future consideration of the artist. Similar recommendations may be derived concerning time periods, genres, and the like.

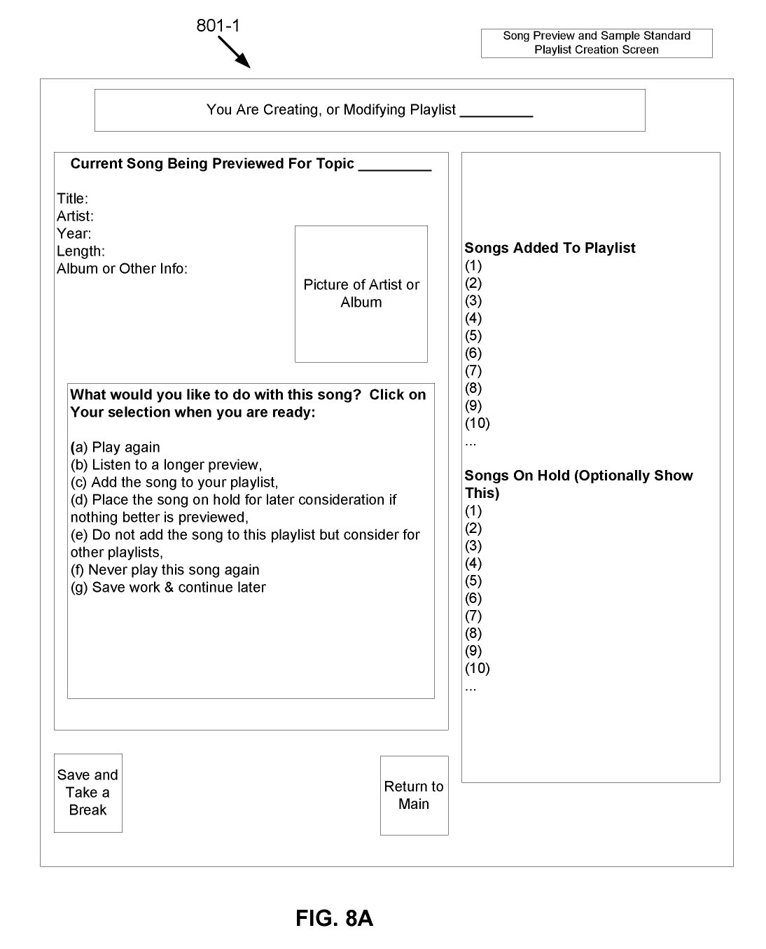

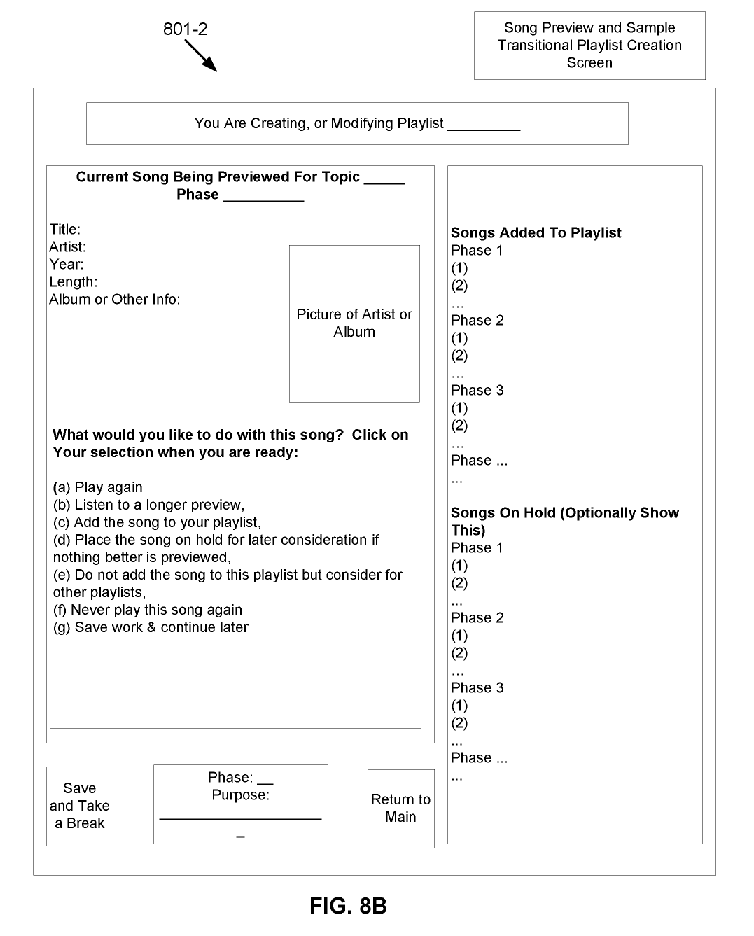

FIG. 8A provides a schematic representation of a sample user interface 801-1 screen as it might exist during the creation or modification of a standard or non-transitional playlist. As indicated, the display, or interface, may show very types of information such as the name and/or topic of the current playlist, information concerning the current song being previewed and possible responses that may be given while or after listening to the song's preview, names of the songs already added to the playlist, and names of the songs placed on hold. Functionality may be provided to the displayed responses such that clicking on them selects them, dragging and dropping them somewhere provides some form of modification or implementation (e.g. 2^{nd} preview), or the like In some implementations, for example, dragging songs from the playlist to the hold area, or vice versa moves them while dragging them to some other part of the screen removes them from their respective list.

FIG. 8B provides a schematic representation of a sample user interface screen 801-1 as it might exist during the creation or modification of a transitional playlist (i.e. a playlist that includes at least one transition from songs having one set of musical properties to songs having a different set of properties). When creating playlists or purchase lists that include transitions, the display screen helps the user understand what phase the current preview song will be used in and what the phase is intended to do. The playlist creation interfaces may also provide the user with some description of the purpose or purposes that the playlist is intended to achieve and the musical properties and/or lyrical properties that the music preferably has to achieve that purpose or those purposes (not shown).

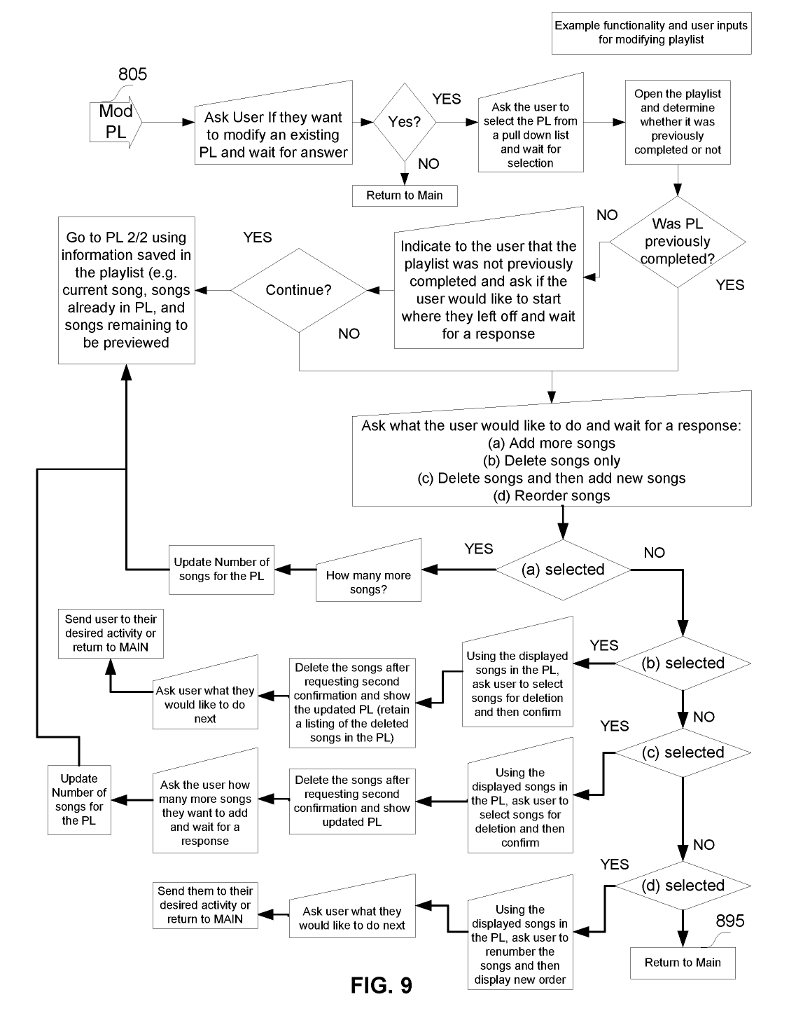

FIG. 9 provides a schematic representation of sample functionality that might be used during modification of a playlist. The functionality starts with block 805 which may be accessed by clicking the fifth button 504 of FIG. 1 which in turn may bring up an appropriate user interface or dialog box which may eventually become one of the interface screens of FIGS. 8A or 8B. It will be understood by those of skill in the art upon review of the teachings herein that various alternative functionalities or processing variations (e.g. order of operations) are possible.

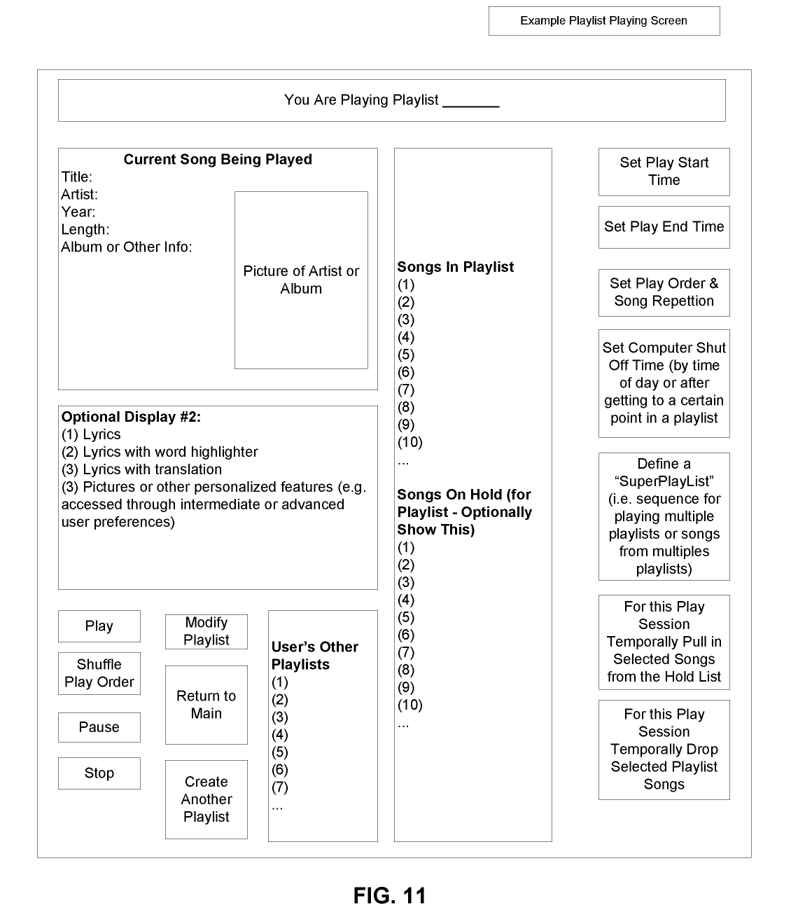

FIG. 10 provides a schematic representation of sample functionality that might be used during the playing of a playlist. The functionality starts with block 905 which may be accessed by clicking the sixth button 504 of FIG. 1 which in turn may bring up an appropriate user interface or dialog box such as that of FIG. 11. It will be understood by those of skill in the art upon review of the teachings herein that numerous alternative functionalities, display formats, and/or processing variations are possible.

FIG. 11 provides a schematic representation of a sample user interface that might be displayed during the playing of a playlist which does not include phase transitions. The interface may provide the ability to select different options or even to drag and drop songs to change play order or temporally or permanently move songs from the hold category to a given playlist. Numerous playlist options may be accessed by the various buttons provided on the interfaces and the associated dialog boxes that may appear upon their activation. In some embodiments, this interface or the playlist creation interfaces may provide for the user to rate songs such that highly rated songs will come up more often when randomized or shuffled playing of the playlist occurs. Such ratings may take a variety of forms such as multiple stars, diamonds, music notes, or the like. If the playlist includes transitions, the playlist song and hold listings on the side would also show phases and attempted movement of songs from one phase to another would result in a warning to the user if the songs attempted to be moved were inappropriate thus providing the user with the opportunity and even need to clarify or cancel the move request.

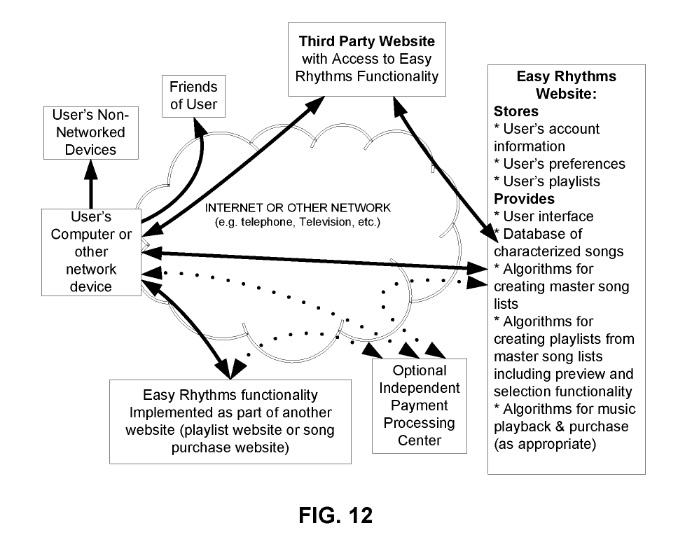

FIG. 12 provides a schematic representation of network communications (over the internet, a telephone network, or a television network) that may be involved in several different implementations of the systems and methods of certain embodiments of the invention (e.g. operating under the name Easy Rhythms) wherein for example Easy Rhythms may be operated as an independent website, e.g. an Easy Rhythms website, accessed by a third party website, or the Easy Rhythms functionality may be embedded in a third party website. As indicated, it may be possible for an Easy Rhythm user to send information directly from Easy Rhythms to another person whether or not they are an Easy Rhythms user. The information sent may take a variety of forms, e.g. a copy of a playlist they just created (e.g. without music or with music if sufficient rights exist), a recommendation to try Easy Rhythms, etc. In some variations Easy Rhythms users may have the ability to share information via email, over social network sites, etc. In some embodiment variations, when music is purchased, users may download the music to their other electronic devices. In still further alternative embodiments, instead of playlists or purchase list resulting in the streaming of music or downloading of music, CDs or other media may be created and product shipped to the user or someone else of the user's choosing.

In view of the teachings herein, many further embodiments, alternative method and systems will be apparent to those of skill in the art. As such, it is not intended that the invention be limited to the particular illustrative embodiments, alternatives, and uses described above but instead that it be solely limited by the claims presented hereafter.

1. A method for creating a fully personalized, functional top specific, multi-song playlist of music, or purchase list of music, for a user, comprising:
a. using an interface to store preferences of the user from a survey of music preferences;
b. using an interface to enter a desired playlist or purchase list topic selected from a predefined group of functional topics;
c. storing song information in a database wherein the database includes a plurality of songs with each song of said plurality directly or indirectly identified with one or more playlist or purchase list topics for which the song is considered applicable by one or more properties of the song selected from the group of properties consisting of (1) the song's musical properties, (2) the song's lyrical properties, and (3) another property that has become associated with the song by a cultural group to which the user belongs;
d. creating a master song list from songs in the database by comparing an initial list of songs from the database with at least two filtering functions wherein one filtering function comprises performing a weighted or non-weighted intersection of potential playlist or purchase list songs with the desired playlist or purchase list topic and a second comprises performing a weighted or non-weighted intersection of potential playlist or purchase list songs in the song list with the user's musical preferences, whereby only songs appropriate to the topic and for the user's preferences are included in the master song list;
e. using an interface, play a preview of a first song in the master song list for the user and solicit and obtain feedback from the user wherein the feedback options are selected from the group consisting of: (1) adding the song to the playlist or purchase list, and (2) not adding the song to the playlist or purchase list; and
f. using the interface, repeat the preview playing, soliciting and obtaining until the playlist or purchase list is complete and then using the interface to make the multi-song playlist or purchase list available to the user for use.

2. A system for creating a fully personalized, functional topic specific, multi-song playlist of music or purchase list of music for a user, comprising:
a. an interface means for entering user preferences into a survey of music preferences;
b. an interface for entering a desired playlist or purchase list topic selected from a predefined group of functional topics;
c. means for storing song information a database wherein the database includes a plurality of songs with each song of said plurality directly or indirectly identified with one or more playlist or purchase list topics for which the song is considered applicable by one or more properties of the song selected from the group of properties consisting of (1) the song's musical properties, (2) the song's lyrical properties, and (3) another property that has become associated with the song by a cultural group to which the user belongs;
d. means for creating a master song list from songs in the database by comparing an initial list of songs from the database with at least two filtering functions wherein one filtering function comprises performing a weighted or non-weighted intersection of potential playlist or purchase list songs with the desired playlist or purchase list topic and a second comprises performing a weighted or non-weighted intersection of potential playlist or purchase list songs in the song list with the user's musical preferences, whereby only songs appropriate to the topic and the user's preferences are included in the master song list;
e. a user interface for playing a preview of a first song in the master song list for the user and for soliciting and obtaining feedback from the user wherein the feedback options are selected from the group consisting of: (1) adding the song to the playlist or purchase list and (2) not adding the song to the playlist or purchase list; and
f. means for repeating the playing, soliciting, and obtaining until the playlist or purchase list is complete and then via user interface making the multi-song playlist or purchase list available for the user to use.

3. A system for creating a fully personalized, functional topic specific, multi-song playlist of music or purchase list of music for a use, comprising:
(a) at least one programmed computing system, comprising:
(i) a visual display;
(ii) at least one input device selected from the group consisting of (1) a touch screen, (2) a keyboard, and (3) a mouse or other pointing device;
(iii) a sound system; and
(iv) a program held in memory of at least one computing system and being executed by at least computing system to provide the following functionality:
(1) ability for a user to access and provide input preferences to a music survey and for the computing system to use provided preferences when creating a master song list;
(2) ability for a user to enter a desired playlist or purchase list topic selected from a predefined group of functional topics;
(3) ability for the computing system to access song information stored in a database wherein the database includes a plurality of songs with each song of said plurality directly or indirectly identified with one or more playlist or purchase list topics for which the song is considered applicable by one or more properties of the song selected from the group of properties consisting of (A) the song's musical properties, (B) the song's lyrical properties, and (3) another property that has become associated with the song by a cultural group to which the user belongs;
(4) creating master song list by comparing an initial list of songs from the song in the database with at least two filtering functions wherein one filtering function comprises performing a weighted or non-weighted intersection of -potential playlist or purchase list songs with the desired playlist or purchase list topic and a second comprises performing a weighted or non-weighted intersection of potential playlist or purchase list songs in the song list with the user's musical preferences;
(5) in combination with the sound system, playing a preview of a first song in the master song list for the user and soliciting and obtaining feedback, via an interface, from the user wherein the feedback options are selected from the group consisting of: (a) adding the song to the playlist or purchase list and (b) not adding the song to the playlist or purchase list; and
(6) repeating the playing, soliciting, and obtaining, via the interface, until the playlist or purchase list is complete and then making the multi-song playlist or purchase list available at the interface for the user to use.

4. The method of claim 1 wherein the purchase list or playlist comprises a playlist.

5. The method of claim 4 additionally comprising producing a plurality of playlists for the same user wherein each of the plurality of playlists is directed to the same topic but contains at least one difference in song inclusion.

6. The method of claim 4 additionally comprising producing a plurality of playlists for the same user and wherein at least two of the playlists are for different topics (i.e. purposes).

7. The method of claim 4 additionally comprising providing a user with the ability to reorder songs in a given playlist after creation of the playlist.

8. The method of claim 4 additionally comprising a display screen for use by the user when creating a playlist that provides data selected from the group consisting of (a) a name of the topic of the playlist, (b) a title for the playlist, (c) a name of the current song being previewed, (d) a name of an artist; (e) the year of the current song, (f) a listing of the songs already selected for inclusion in the playlist, (g) a listing of the songs placed on hold, and (h) an indication of the current song number.

9. The method of claim 4 additionally comprising storing with a given created playlist not only the songs entered into the playlist but also information concerning the master song list, the songs already previewed from the master song list, and the songs placed on hold.

10. The method of claim 4 additionally comprising storing with a given playlist information about the user preferences and database that gave rise to the master song list.

11. The method of claim 4 additionally comprising functionality for playing playlists wherein the functionality is selected from the group consisting of: (a) playing a selected playlist immediately, (b) playing a plurality of selected playlists in a selected order; (c) playing a selected playlist in a shuffled order; (d) playing a selected playlist in a default order; (e) playing one or more selected playlists at one or more predefined start times; (f) playing one or more selected playlists until a predefined stop time has been reached or predefined increment of time has passed; (g) setting a maximum volume level for all songs to be played during a given period; and (h) setting a range for the dynamic level of the songs to be played during a given period;

12. The method of claim 4 additionally comprising the playlist including multiple phases wherein at least two of the phases are characterized by different musical properties (e.g. beat and meter, dynamics, harmony, key, musical instruments or voice, pitch, rhythm, tempo, texture, timbre, and/or the like) or lyrical properties (e.g. vocal message being conveyed).

13. The method of claim 12 wherein the different musical properties or lyrical properties are limited to musical properties.

14. The method of claim 12 wherein the different musical properties or lyrical properties include both musical properties and lyrical properties.

15. The method of claim 1 wherein a display interface provides karaoke-type lyric highlighting during song playing.

16. The method of claim 4 wherein a user interface provides an ability to share a user's playlist with another person via a social network.

17. The method of claim 5 wherein the storage of preference information can be different for different topics.
